(19) United States
(12) Patent Application Publication
(10) Pub. No.: US 2023/0289698 A1
(43) Pub. Date: Sep. 14, 2023

(54) System and Methods for Monitoring Related Metrics

(71) Applicant: System Inc., Malden on Hudson, NY (US)

(72) Inventors: Adam Bly, New York City, NY (US); David Kang, Brooklyn, NY (US)

(21) Appl. No.: 18/118,274

(22) Filed: Mar. 7, 2023

Related U.S. Application Data
(60) Provisional application No. 63/318,170, filed on Mar. 9, 2022.

(51) Int. Cl. G06Q 10/0639

(52) U.S. Cl. CPC G06Q 10/06393

(57) ABSTRACT

A system and methods for improving the ability of a business or other entity to monitor business related metrics (such as KPIs) and the evaluation of the quality of the underlying data used to generate those metrics.

### CROSS REFERENCE TO RELATED APPLICATION

This application claims the benefit of U.S. Provisional Application No. 63/318,170, filed Mar. 9, 2022, and titled “System and Methods for Monitoring Related Metrics”, the contents of which is incorporated in its entirety by this reference.

Note that references to “System” in the context of an architecture or to the System architecture or platform herein refer to the architecture, platform, and processes for performing statistical search and other forms of data organization described in U.S. patent application Ser. No. 16/421,249, entitled “Systems and Methods for Organizing and Finding Data”, filed May 23, 2019 (now issued U.S. Pat. No. 11,354,587, dated Jun. 7, 2022), which claims priority from U.S. Provisional Patent Application Ser. No. 62/799,981, entitled “Systems and Methods for Organizing and Finding Data”, filed Feb. 1, 2019, the entire contents of which are incorporated by reference in their entirety into this application.

### BACKGROUND

Data-driven organizations track key performance indicators (referred to as KPIs) and other metrics to gauge the organization's status and to assist in making strategic decisions. KPIs and metrics are increasingly part of news reporting as well (the level and percent change in the Dow Jones Industrial Average, the S&P 500 Index, the stock price of a key company, or the level and change in new weekly unemployment insurance claims, as examples). Current approaches for monitoring such metrics rely on dashboards, data catalogs, and KPI trackers to provide a user with information about specific KPIs.

While useful, the conventional approaches have limitations and disadvantages. For one, the conventional approaches provide information about KPIs in relative isolation from other factors. Further, conventional approaches do not perform the tracking and monitoring of key metrics in the context of the modeling and statistical association work that is done by modern data science and analytics teams. This limits the ability of users to understand the significance of changes in KPIs and how those changes may be related to or may influence other metrics. This prevents a user from obtaining a more complete and more accurate understanding of the relationships between the various metrics, the data used to generate the metrics, and the performance of the company (or other entity) that generated the underlying data.

Developing tools to evaluate statistical relationships within and between datasets and to automate the process of generating metrics and decisions based on those datasets requires dedicated resources that may not be readily available to or affordable for many businesses. Embodiments of the systems and methods described herein are directed to solving these and related problems individually and collectively.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments of the disclosure are directed to a system and methods for improving the ability of a business or other entity to monitor business related metrics (such as KPIs) and the evaluation of the quality of the underlying data used to generate those metrics. In some embodiments, the disclosed systems and methods may comprise elements, components, functions, operations, or processes that are configured and operate to provide one or more of:
Creating a feature graph comprising a set of nodes and edges, where;
   A node represents one or more of a concept, a topic, a dataset, metadata, a model, a metric, a variable, a measurable quantity, an object, a characteristic, a feature, or a factor as non-limiting examples;
      In some embodiments, a node may be created in response to discovery of or obtaining access to a dataset, to metadata, to a model, generating an output from a trained model, generating metadata regarding a dataset, or developing an ontology or other form of hierarchical relationship, as non-limiting examples;
   An edge represents a relationship between a first node and a second node, for example a statistically significant relationship, a dependence, or a hierarchical relationship, as non-limiting examples;
      In some embodiments, an edge may be created connecting a first and a second node to represent a statistically valid relationship between two nodes as determined by a statistical analysis, a machine learning model, or a study;
   A label associated with an edge may indicate an aspect of the relationship between the two nodes connected by the edge, such as the metadata upon which the relationship between two nodes is based, or a dataset supporting a statistically significant relationship between the two nodes, as non-limiting examples;
Providing a user with user interface display screens, tools, features, and selectable elements to enable the user to perform one or more of the functions of:
   Identifying a metric of interest (such as a KPI) for monitoring or tracking;
      Wherein the metric of interest may be generated by a trained model, a formula, an equation, or a rule-set, and further may be based on, generated from, or derived from underlying data that is a function of time;
   Defining a rule that describes when an alert regarding the behavior of the identified metric should be generated;
      Such a rule may be based on an absolute value, a change to the value, a percentage change, a percentage change over a time period, or exceeding or falling below a threshold value, as non-limiting examples;
   Defining how the result of applying the rule is to be identified or indicated on a user interface display;
      This may depend on the user's preference and/or the value or type of change to the metric, as examples;
   Allowing a user to select a metric for which an alert has been generated and in response, providing information regarding the metric's changes in value overtime, the rule satisfied or activated that resulted in the alert, the metric's relationship(s) (if relevant) to other metrics, and available information regarding the datasets, machine learning models, rules, formulas, or other factors used to generate the metric, as non-limiting examples;
Generating a recommendation for the user regarding a different metric or set of metrics that may be of value to monitor, a dataset that may be useful to examine, metadata that may be relevant to the identified metrics, or other aspect of the underlying data or metrics of potential interest to the user;
   Where the recommendation may result (at least in part) from an output generated by a trained machine learning model, a statistical analysis, a study, or other form of data collection or evaluation.

In one embodiment, the disclosure is directed to a system for improving the ability of a business or other entity to monitor business related metrics (such as KPIs) and the evaluation of the quality (and hence accuracy and reliability) of the underlying data. The system may include a set of computer-executable instructions stored in (or on) one or more non-transitory computer-readable media, and an electronic processor or co-processors. When executed by the processor or co-processors, the instructions cause the processor or co-processors (or an apparatus or device of which they are part) to perform a set of operations that implement an embodiment of the disclosed method or methods.

In one embodiment, the disclosure is directed to one or more non-transitory computer-readable media including a set of computer-executable instructions, wherein when the set of instructions are executed by an electronic processor or co-processors, the processor or co-processors (or an apparatus or device of which they are part) perform a set of operations that implement an embodiment of the disclosed method or methods.

In some embodiments, the systems and methods described herein may provide services through a SaaS or multi-tenant platform. The platform provides access to multiple entities, each with a separate account and associated data storage. Each account may correspond to a user, set of users, an entity providing datasets for evaluation and use in generating business-related metrics, or an organization, for example. Each account may access one or more services, a set of which are instantiated in their account, and which implement one or more of the methods or functions described herein.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary or specific embodiments described herein are not intended to be limited to the forms described. Rather, the present disclosure covers all modifications, equivalents, and alternatives falling within the scope of the appended claims.

### BRIEF DESCRIPTION OF THE DRAWINGS

Embodiments of the invention in accordance with the present disclosure will be described with reference to the drawings, in which:

FIG. 1(a) is a block diagram illustrating a set of elements, components, functions, processes, or operations that may be part of a platform architecture 100 in which an embodiment of the disclosed system and methods for metrics monitoring may be implemented;

FIG. 1(b) is a flow chart or flow diagram illustrating a process, method, function, or operation for constructing a Feature Graph 150 using an implementation of an embodiment of the systems and methods disclosed herein;

FIG. 1(c) is a flow chart or flow diagram illustrating a process, method, function, or operation for an example use case in which a Feature Graph is traversed to identify potentially relevant datasets, and which may be implemented in an embodiment of the systems and methods disclosed herein;

FIG. 1(d) is a diagram illustrating an example of part of a Feature Graph data structure that may be used to organize and access data and information, and which may be created using an implementation of an embodiment of the system and methods disclosed herein;

FIG. 2(a) is a block diagram illustrating a set of elements, components, functions, processes, or operations that may be part of a platform architecture in which an embodiment of the disclosed system and methods for metrics monitoring may be implemented. Specifically, FIG. 2(a) depicts how a change in features from a dataset stored in a cloud database service may be monitored using an implementation of the disclosed Metrics Monitoring capability;

FIG. 2(b) is a flow chart or flow diagram illustrating a set of elements, components, functions, processes, or operations that may be executed as part of a platform architecture in which an embodiment of the disclosed system and methods for metrics monitoring may be implemented. Specifically, FIG. 2(b) depicts certain of the steps in FIG. 2(a) with a greater focus on the different user interactions and software elements that contribute to how the Metrics Monitoring functionality is implemented and made available to users;

FIG. 2(c) is an example of a user interface display illustrating the most recent value, the percent change to that value and identification of the subpopulation with the biggest change (which can be calculated when the metric is created as an aggregation of values in a table where there are multiple subpopulations/dimensions in the data);

FIG. 2(d) is an example of a user interface display illustrating the Metrics Monitoring panel on the page for Weekly Active User, a metric. On the platform feature graph to the left, Metrics Monitoring is turned on for other metrics, and the edges between the nodes in the graph contain metadata that describe the statistical relationships between the metrics;

FIG. 2(e) is an example of a user interface display illustrating the platform Catalog view of Metrics Monitoring, where it is turned on for the eight metrics on this page;

FIG. 2(f) is an example of a user interface display illustrating a notification or notifications for the Metrics Monitoring function;

FIG. 2(g) is an example of a user interface display illustrating a simplified rule setting dialog. The condition that will apply to this metric will be when the absolute value of the percent change is strictly greater than 4.5;

FIG. 2(h) is a diagram illustrating elements, components, or processes that may be present in or executed by one or more of a computing device, server, platform, or system configured to implement a method, process, function, or operation in accordance with some embodiments; and

FIGS. 3-5 are diagrams illustrating an architecture for a multi-tenant or SaaS platform that may be used in implementing an embodiment of the systems and methods described herein.

Note that the same numbers are used throughout the disclosure and figures to reference like components and features.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, or controller, as non-limiting examples) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory computer-readable data storage media or elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the disclosure may be implemented in the form of an application, a sub-routine that is part of a larger application, a “plug-in”, an extension to the functionality of a data processing system or platform, or other suitable form. The following detailed description is, therefore, not to be taken in a limiting sense.

As mentioned, in some embodiments, the systems and methods described herein may provide services through a SaaS or multi-tenant platform. The platform provides access to multiple entities, each with a separate account and associated data storage. Each account may correspond to a user, set of users, an entity, or an organization, for example. Each account may access one or more services, a set of which are instantiated in their account, and which implement one or more of the methods or functions described herein.

Embodiments of the disclosure are directed to a system and methods for improving the ability of a business or other entity to monitor business related metrics (such as KPIs) and to evaluate the quality of the underlying data used to generate those metrics.

As a general principle, it is desirable that data used to make decisions be relevant (or in some cases, “sufficiently” relevant) to a task being performed or a decision being made. Making a reliable data-driven decision or prediction requires data not just about the desired outcome of a decision or the target of a prediction, but data about the variables (ideally all, but at least the ones most strongly) statistically associated with that outcome or target. Unfortunately, using conventional approaches it is difficult to discover which variables have been demonstrated to be statistically associated with an outcome or target and to access data about those variables to better evaluate the reliability of decisions made based on those variables.

In many situations, discovery of and access to data is made more efficient by representing data in a particular format or structure. The format or structure may include labels for one or more columns, rows, or fields in a data record. Conventional approaches to identifying and discovering data of interest are typically based on semantically matching words with labels in (or referring to, or about) a dataset. While this method is useful for discovering and accessing data about a topic (a target or an outcome, for example) which may be relevant, it does not address the problem of discovering and accessing data about variables that cause, affect, predict, or are otherwise statistically associated with a topic of interest.

Embodiments of the system and methods disclosed herein may include the construction or creation of a graph database. In the context of this disclosure, a graph is a set of objects that are presented together if they have some type of close or relevant relationship. An example is two pieces of data that represent nodes and that are connected by a path. One node may be connected to many nodes, and many nodes may be connected to a specific node. The path or line connecting a first and a second node or nodes is termed an “edge”. An edge may be associated with one or more values; such values may represent a characteristic of the connected nodes, or a metric or measure of the relationship between a node or nodes (such as a statistical parameter), as non-limiting examples. A graph format may make it easier to identify certain types of relationships, such as those that are more central to a set of variables or relationships, or those that are less significant. Graphs typically occur in two primary types: “undirected”, in which the relationship the graph represents is symmetric, and “directed”, in which the relationship is not symmetric (in the case of directed graphs, an arrow instead of a line may be used to indicate an aspect of the relationship between the nodes).

In some embodiments, information and data are represented in the form of a data structure termed a “Feature Graph” herein. A Feature Graph is a graph or diagram that includes nodes and edges, where the edges serve to “connect” a node to one or more other nodes. A node in a Feature Graph may represent a variable (i.e., a measurable quantity), an object, a characteristic, a feature, or a factor, as examples. An edge in a Feature Graph may represent a measure of a statistical association between a node and one or more other nodes.

The association may be expressed in numerical and/or statistical terms and may vary from an observed (or possibly anecdotal) relationship to a measured correlation, to a causal relationship, as examples. The information and data used to construct a Feature Graph may be obtained from one or more of a scientific paper, an experiment, a result of a machine learning model, human-made or machine-made observations, or anecdotal evidence of an association between two variables, as non-limiting examples.

As one example, a Feature Graph may be constructed by accessing a set of sources that include information regarding a statistical association between a topic of a study and one or more variables considered in the study. The information contained in the sources is used to construct a data structure or representation that includes nodes and edges connecting nodes. Edges may be associated with information regarding the statistical relationship between two nodes. One or more nodes may have a dataset associated with it, with the dataset accessible using a link or other form of address or access element. Embodiments may include functionality that allows a user to describe and execute a search over the data structure to identify datasets that may be relevant to training a machine learning model, with the model being used in making a specific decision or classification.

Thus, embodiments may generate a data structure which includes nodes, edges, and links to datasets. The nodes and edges represent concepts, topics of interest, or a topic of a previous study. The edges represent information regarding a statistical relationship between nodes. Links (or another form of address or access element) provide access to datasets that establish (or support, demonstrate, etc.) a statistical relationship between one or more variables that were part of a study, or between a variable and a concept or topic.

One of the responsibilities for data science and data engineering teams is managing “Data Quality.” This refers to the appropriateness and applicability of collected or acquired data for use in data analyses and machine learning (ML) modeling. The assessment of data quality may include collecting information or facts about the data, such as source(s), date(s) of collection, and information about the collection process, as well as verification of different statistical properties of the data. These statistical properties may be used to identify datasets that are “better” (that is, more accurate or reliable) candidates for use in training a model or in evaluating the performance of a business or other entity.

There are conventional tools that provide users detailed information about the data itself, and tools that automate the process for verifying data quality. However, assessing statistical characteristics of a dataset typically involves writing custom computer code to either query databases or otherwise access data, and then applying rules or heuristics (using additional custom code) to determine whether accessed data (or subsets contained within that data) are within the bounds of the rules or heuristics. This places a burden on many entities and requires an allocation of resources which they may not have access to or be able to afford.

Data quality can also impact the evaluation of machine learning models. Machine learning (ML) includes the study of algorithms and statistical models that computer systems use to perform a specific task without using explicit instructions, relying instead on identifying patterns and applying inference processes. Machine learning algorithms build a mathematical “model” based on sample data (known as “training data”) and information about what the data represents (termed a label or annotation), to make predictions, classifications, or decisions without being explicitly programmed to perform the task.

Machine learning algorithms are used in a wide variety of applications, including email filtering and computer vision, where it is difficult or not feasible to develop a conventional algorithm to effectively perform the task. Because of the importance of the ML model being used for a task, researchers and developers of machine learning based applications spend time and resources to build the most “accurate” predictive models for their use-case. The evaluation of a model's performance and the importance of each feature in the model are typically represented by specific metrics that are used to characterize the model and its performance. These metrics may include, for example, model accuracy, the confusion matrix, Precision (P), Recall (R), Specificity, the F1 score, the Precision-Recall curve, the ROC (Receiver Operating Characteristics) curve, or the PR vs. ROC curve. Each metric may provide a slightly different way of evaluating a model or certain aspect(s) of a model's performance.

An important element of modern “data-driven” business decision making is the identification of KPIs (“key performance indicators”, or “key metrics”). Many company leadership teams are focused on maintaining KPI growth or otherwise using KPIs as the primary “signals” or indicators for the health or performance of their companies. The importance of KPIs to business decisions and the quality of the data used in generating those KPIs are related. This is because the utility of KPIs and the justification for using them as indicators for company or team performance depends on their applicability and the statistical (or other) measure of the accuracy and/or reliability of the underlying data used to calculate a KPI. Companies may invest in analysts and engineers to build “dashboards” and other analytics tools to highlight levels and changes in their company's KPIs and inform decision makers regarding those changes.

Due to the significance of the data used in determining a KPI and/or in training a model and its potential impact on the model's performance, the characteristics of a dataset can be important factors in selecting training data and interpreting the results from a trained model. This can be particularly important in a business setting where data generated by a business is being used as training data or an input to a trained model to generate a metric of interest to the company. For example, a trained model may be used to generate a KPI that represents an aspect of the operation of the business, such as revenue growth, profit margin, marketing costs, or sales conversion rate, as non-limiting examples.

In some embodiments, the described user interface (UI) and user experience (UX) may be implemented as part of an underlying data analysis platform, such as the System platform referenced herein, and described in U.S. patent application Ser. No. 16/421,249 (now issued U.S. Pat. No. 11,354,587), entitled “Systems and Methods for Organizing and Finding Data”. The disclosed platform discovers, stores, and in some cases may generate statistical relationships between data, concepts, variables, or other features. The relationships may be generated from machine learning models or programmatically run correlations.

The disclosed Metrics Monitoring functionality provides a way to leverage the System data organization and analysis platform to show levels and changes in KPIs, similar to how conventional approaches such as dashboards, data catalogs, and KPI trackers may do. However, instead of this function being performed in isolation, the metadata about the “status” of a metric (such as its level and changes over time) may be displayed along with the relationship of that metric to other metrics that are measured or otherwise being monitored. The Metrics Monitoring functionality shows each metric's level and change in the context of those levels, along with changes in other metrics. However, in contrast to conventional approaches, this context is not based purely on concurrency (which can lead to spurious associations between metrics and incorrect causal assumptions), but on statistical relationships driven by the platform's underlying cataloging of machine learning model and correlation-based associations.

Although the Metrics Monitoring capability is designed to be a part of the disclosed platform, one of ordinary skill in the art (e.g., a software engineer with an understanding of graph databases and HTTP requests) should find the disclosure enabling and be able to implement a metrics monitoring capability in the programming language of their choosing. Since the purpose of Metrics Monitoring is to track changes in important KPIs/metrics, Metrics Monitoring assumes that there is a source of data that is updating in an event-driven or otherwise automated fashion (which is often the case for datasets that are stored in cloud database services). The frequency with which these data are updated is not as important; Metrics Monitoring can be valuable to users in the financial services sector, where data is assumed to be updated on a nearly continuous basis, but it may also be used by individuals conducting scientific research and working with administrative data (often published by governmental entities), which might be updated at a quarterly, annual, or even decennial rate.

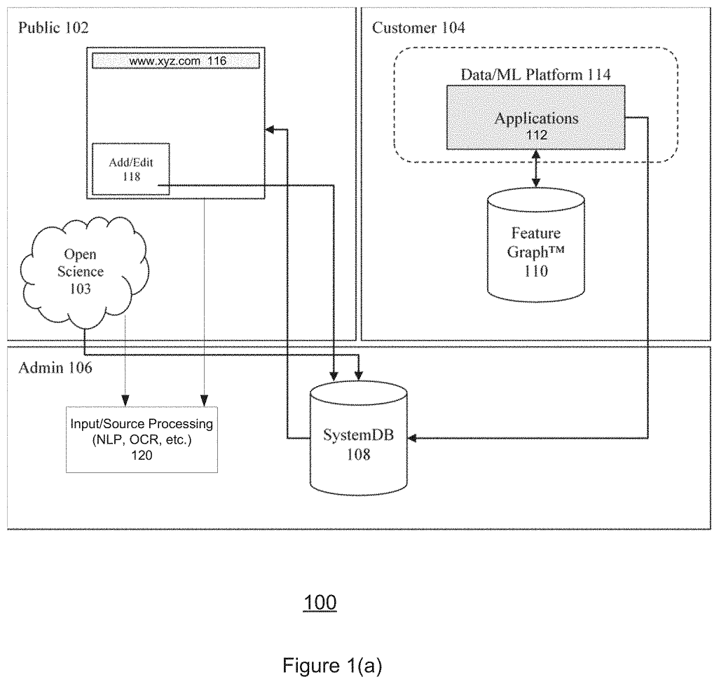

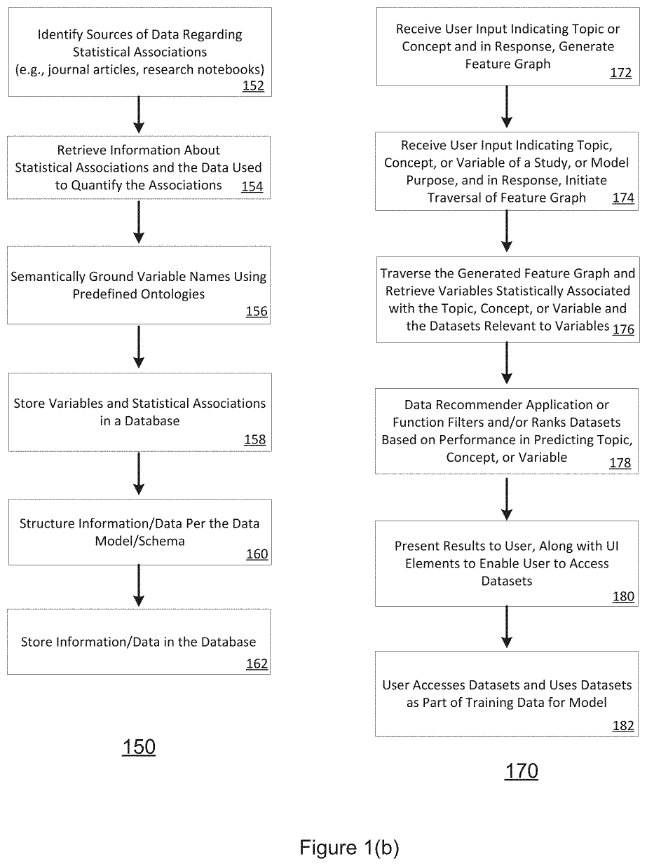

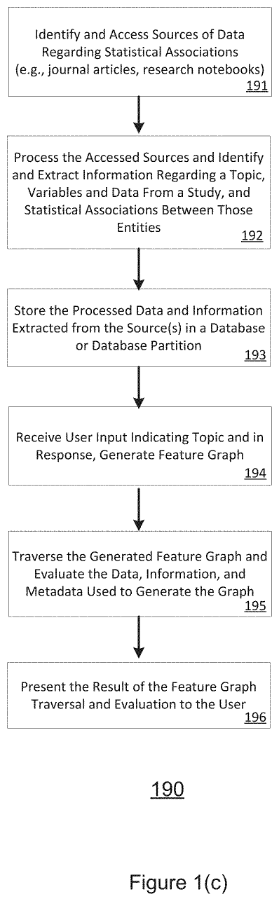

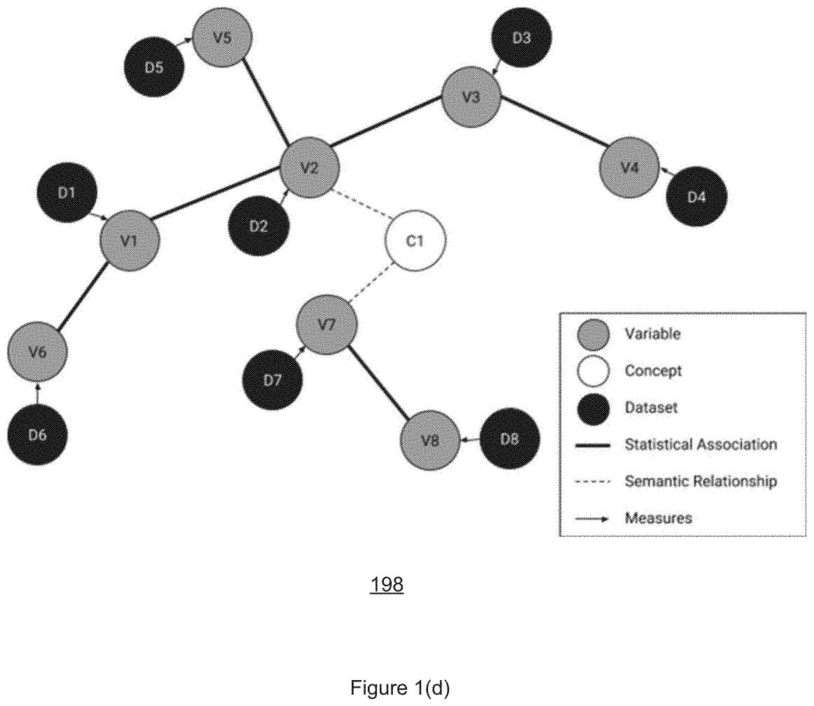

FIG. 1(a) is a block diagram illustrating a set of elements, components, functions, processes, or operations that may be part of a platform architecture 100 in which an embodiment of the disclosed system and methods for metrics monitoring may be implemented. A brief description of the example architecture is provided below:

### Architecture

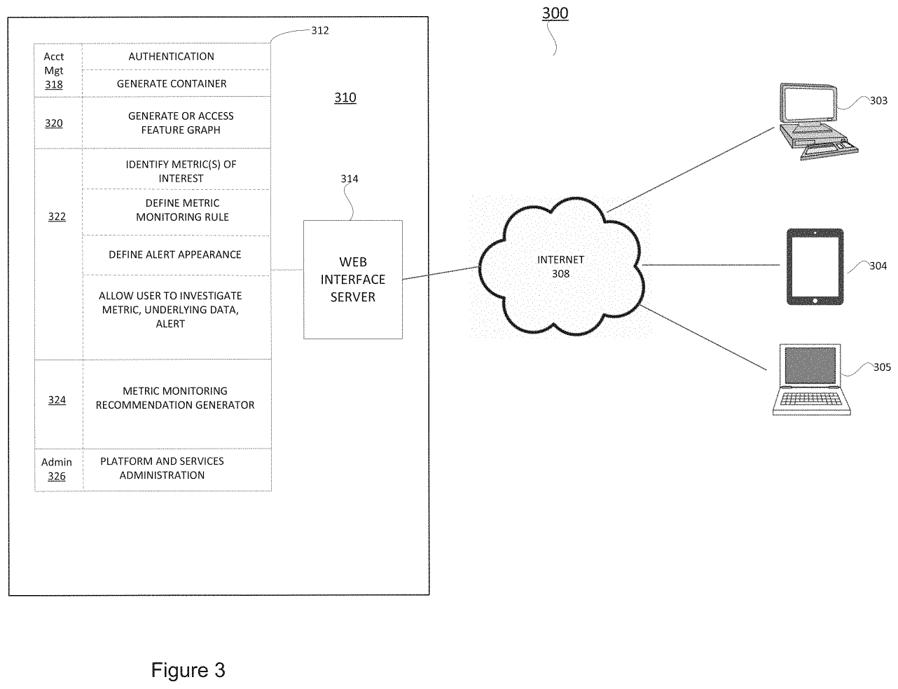

In some embodiments, the architecture elements or components illustrated in FIG. 1(a) may be distinguished based on their function and/or based on how access is provided to the elements or components. Functionally, the system's architecture 100 distinguishes between:
   information/data access and retrieval (illustrated as Applications 112 Add/Edit 118, and Open Science 103)—these are the sources of information and descriptions of experiments, studies, machine learning models, or observations that provide the data, variables, topics, concepts, and statistical information that serve as a basis for generating a Feature Graph or similar data structure;
   a database (illustrated as SystemDB 108)—an electronic data storage medium or element, and utilizing a suitable data structure or schema and data retrieval protocol/methodology; and
   applications (illustrated as Applications 112 and website 116)—these are executed in response to instructions or commands received from a public user (Public 102), Customer 104, and/or an Administrator 106. The applications may perform one or more processes, operations or functions, including, but not limited to:
      searching SystemDB 108 or a Feature Graph 110 and retrieving variables, datasets and other information of relevance to a user query;
      identifying specific nodes or relationships of a Feature Graph;
      writing data to SystemDB 108 so that the data may be accessed by the Public 102 or others outside of the Customer or business 104 that owns or controls access to the data (note that in this sense, the Customer 104 is serving as an element of the information or data retrieval architecture or sources);
      generating a Feature Graph from specified datasets;
      characterizing a specific Feature Graph according to one or more metrics or measures of complexity, relative degree of statistical significance, or other aspect or characteristic; and/or
      generating and accessing recommendations for datasets to use in training a machine learning model;
From the perspective of access to the system 100 and its capabilities, the system's architecture distinguishes between elements or components accessible to the public 102, elements or components accessible to a defined customer, business, organization or set of businesses or organizations (such as an industry consortium or “data collaborative” in the social sector) 104, and elements or components accessible to an administrator of the system 106;
Information/data about or demonstrating statistical associations between topics, concepts, factors, or variables may be retrieved (i.e., accessed and obtained) from multiple sources. These may include (but are not limited to, or required to include) journal articles, technical and scientific publications and databases, digital “notebooks” for research and data science, experimentation platforms (for example for A/B testing), data science and machine learning platforms, and/or a public website (element/website 116) where users can input observed statistical (or anecdotal) relationships between observed variables and topics, concepts, or goals;
   For example, using natural language processing (NLP), natural language understanding (NLU), and/or computer vision for processing images (as suggested by Input/Source Processing element 120), components of the information and data retrieval architecture may scan (such as by using optical character recognition, OCR) or “read” published or otherwise accessible scientific journal articles and identify words and/or images that indicate a statistical association has been measured (for example, by recognizing the term “increases” or another relevant term or description), and in response, retrieve information and data about the association and about datasets that measure (e.g., provide support for) the association (as suggested by the element labeled “Open Science” 103 in the figure and by step or stage 202 of FIG. 1(a));
   Other components of the information and data retrieval architecture (not shown) may provide users with a way to input code into their digital “notebook” (e.g., a Jupyter Notebook) to retrieve the metadata output of a machine learning experiment (e.g., the “feature importance” measurements of the features used in a given model) and information about datasets used in the experiment;
   Note that in some embodiments, information and data retrieval is generally happening on a regular or continuing basis, providing the system 100 with new information to store and structure, and thereby expose to users;
In some embodiments, algorithms and model types (e.g., Logistic Regression), model parameters, numerical values (e.g., 0.725), units (e.g., log loss), statistical properties (e.g., p-value=0.03), feature importance, feature rank, model performance (e.g., AUC score), and other statistical values regarding an association are identified and stored after being retrieved;
   Given that researchers and data scientists may employ different words or terms to describe the same or a closely similar concept, variable names (e.g., “aerobic exercise”) may be stored as retrieved and then be semantically grounded to (i.e., linked or associated with) public domain ontologies (e.g., Wikidata) to facilitate clustering of variables (and the associated statistical associations) based on common or typically synonymous or closely related terms and concepts;
      For example, a variable labeled as “log_house_sale_price” by a given user might be semantically associated by the system (and further affirmed by the user) with “Real Estate Price,” a topic in Wikidata with a unique ID;
A central database (“SystemDB” 108 in the figure) stores the information and data that has been retrieved and its associated data structures (i.e., nodes, edges, values), as disclosed herein. An instance or projection of the central database containing all or a subset of the information and data stored in SystemDB is made available to a specific customer, business, or organization 104 (or group thereof) for their use, typically in the form of a “Feature Graph” 110;
   Because access to a particular Feature Graph may be restricted to certain individuals associated with a given business or organization, it may be used to represent information and data about variables and statistical associations that may be considered private or proprietary to the given business or organization 104 (such as employment data, financial data, product development data, business metrics, or R&D data, as non-limiting examples);
   Each customer or user is provided with their own instance of SystemDB in the form of a Feature Graph. Feature Graphs typically read data from SystemDB concurrently (and in most cases frequently), thereby ensuring that users of a Feature Graph have access to the most current information, data, and knowledge stored in SystemDB;
Applications 112 may be developed (“built”) on top of a Feature Graph 110 to perform a desired function, process, or operation; an application may read data from it, write data to it, or perform both functions. An example of an application is a recommender system for datasets (referred to as a “Data Recommender” herein). A customer 104 using a Feature Graph 110 can use a suitable application 112 to “write” information and data to SystemDB 108; this may be helpful should they wish to share certain information and data with a broader group of users outside their organization or with the public;
   An application 112 may be integrated with a Customer's 104 data platform and/or machine learning (ML) platform 114. An example of a data platform is Google Cloud Storage. An ML (or data science) platform could include software such as Jupyter Notebook;
      Such a data platform integration would, for example, allow a user to access a feature (such as one recommended by a Data Recommender application) in the customer's data storage or other data repository. As another example, a data science/ML platform integration would, for example, allow a user to query the Feature Graph from within a notebook;
   Note that in addition to, or instead of integration with a Customer's data platform and/or machine learning (ML) platform, access to an application may be provided by the Administrator to a Customer using a suitable service platform architecture, such as Software-as-a-Service (SaaS) or similar multi-tenant architecture. A further description of the primary elements or features of such an architecture is described herein with reference to FIGS. 3-5;
In some embodiments, a web-based application may be made accessible to the Public 102. On a website (represented by www.xyz.com 116), a user could be enabled to read from and write to SystemDB 108 (as suggested by the Add/Edit functionality 118 in the figure) in a manner similar to that experienced with a website such as Wikipedia; and
In some embodiments, data stored in SystemDB 108 and exposed to the public at www.xyz.com 116 may be made available to the public in a manner similar to that experienced with a website such as Wikipedia.

Once information and data are accessed and processed for storage in a database (which may contain both unprocessed data and information, processed data and information, and data and information stored in the form of a data model), a Feature Graph that contains a specified set of variables, topics, targets, or factors may be constructed. The Feature Graph for a particular user may include all the data and information in the platform database 108 or a subset thereof. For example, the Feature Graph (110 in FIG. 1(a)) for a specific Customer 104 may be constructed based on selecting data and information from SystemDB 108 that satisfy conditions such as the applicability of a given domain (e.g., public health) to the domain of concern of a customer (e.g., media). In deploying, generating, or constructing a Feature Graph for a specific customer or user, data in database 108 may be filtered to improve performance by removing data that would not be relevant to the problem, concept, or topic being investigated.

In some embodiments or uses, the data used to generate a Feature graph may be proprietary to an organization or user. For example, the data used to construct a Feature graph may be obtained from an experiment, a set of customers or users, or a specific database of protected data, as non-limiting examples.

FIG. 1(b) is a flow chart or flow diagram illustrating a process, method, function, or operation for constructing a Feature Graph 150 using an implementation of an embodiment of the systems and methods disclosed herein. FIG. 1(c) is a flow chart or flow diagram illustrating a process, method, function, or operation for an example use case in which a Feature Graph is traversed to identify potentially relevant datasets and/or perform another function of interest (such as one resulting from execution of a specific application, such as those suggested by element 112 in FIG. 1(a)), and which may be implemented in an embodiment of the systems and methods disclosed herein.

As shown in the figures (specifically, FIG. 1(b)), a Feature Graph is constructed or created by identifying and accessing a set of sources that contain information and data regarding statistical associations between variables or factors used in a study (as suggested by step or stage 152). This type of information may be retrieved on a regular or continuing basis to provide information regarding variables, statistical associations and the data used to support those associations (as suggested by 154). As disclosed herein, this information and data is processed to identify variables used or described in those sources, and the statistical associations between one or more of those variables and one or more other variables.

Continuing with FIG. 1(b), at 152 sources of data and information are accessed. The accessed data and information are processed to identify variables and statistical associations found in the source or sources 154. As described, such processing may include image processing (such as OCR), natural language processing (NLP), natural language understanding (NLU), or other forms of analysis that assist in understanding the contents of a journal paper, research notebook, experiment log, or other record of a study or investigation.

Further processing may include linking certain of the variables to an ontology (e.g., the International Classification of Diseases) or other set of data that provides semantic equivalents or semantically similar terms to those used for the variables (as suggested by step or stage 156). This assists in expanding the variable names used in a specific study to a larger set of substantially equivalent or similar entities or concepts that may have been used in other studies. Once identified, the variables (which, as noted may be known by different names or labels) and statistical associations are stored in a database (158), for example SystemDB 108 of FIG. 1(a).

The results of processing the accessed information and data are then structured or represented in accordance with a specific data model (as suggested by step or stage 160); this model will be described in greater detail herein, but it generally includes the elements used to construct a Feature Graph (i.e., nodes representing a topic or variable, edges representing a statistical association, measures including a metric or evaluation of a statistical association). The data model is then stored in the database (162); it may be accessed to construct or create a Feature Graph for a specific user or set of users.

As noted, the process or operations described with reference to FIG. 1(b) enable the construction of a graph containing nodes and edges linking certain of the nodes (an example of which is illustrated in FIG. 1(d)). The nodes represent topics, targets or variables of a study or observation, and the edges represent a statistical association between a node and one or more other nodes. Each statistical association may be associated with one or more of a numerical value, model type or algorithm, and statistical properties that describe the strength, confidence, or reliability of a statistical association between the nodes (i.e., the variables, factors, or topics) connected by the edge. Note that the numerical value, model type or algorithm, and the statistical properties associated with the edge may be indicative of a correlation, a predictive relationship, a cause-and-effect relationship, or an anecdotal observation, as non-limiting examples.

FIG. 1(c) is a flow chart or flow diagram illustrating a process, method, function, or operation 190 that may be used to construct a Feature Graph for a user, in accordance with an embodiment of the disclosed system and methods. In one embodiment, this may include the following steps or stages (some of which are duplicative of those described with reference to FIG. 1(b)):
Identifying and accessing source data and information (as suggested by step or stage 191);
   In one embodiment, this may represent publicly available data and information from journals, research periodicals, or other publications describing studies or investigations;
   In one embodiment, this may represent proprietary data and information, such as experimental results generated by an organization, research topics of interest to the organization, or data collected by the organization from customers or clients;
Processing the accessed data and information (as suggested by step or stage 192);
   In one embodiment, this may include the identification and extraction of information regarding one or more of a topic of a study or investigation, the variables or parameters considered in the study or investigation, and the data or datasets used to establish a statistical association between one or more variables and/or between a variable and the topic, along with a measure of the statistical association(s) in the form of a metric, relationship, or similar quantity;
   In one embodiment, this processing may be performed automatically or semi-automatically by use of a trained model that utilizes a language model or language embedding technique to identify data and information of interest or relevance;
Storing the processed data and information in a database (as suggested by step or stage 193);
   In one embodiment, the database may include one or more partitions to isolate data obtained from an organization, from a set of sources, or from a set of populations into a separate dataset to be used to generate a Feature Graph;
      This may be a useful approach where a set of data is obtained from a proprietary study, a specific population, or is otherwise subject to regulation or constraints (such as a privacy or security regulation);
   In some embodiments, the processed data and information may be stored in accordance with a specific data schema that includes specific labels or fields;
Receiving a user input indicating a topic of interest and in response, generating a Feature Graph (as suggested by step or stage 194);
   In one embodiment, the user input may specify sources, dates, thresholds, or other forms of constraints that are used as a filtering mechanism for the data and information used to generate the Feature Graph;
Traversing the Feature Graph, and evaluating the data, information, and metadata used to generate the Feature Graph (as suggested by step or stage 195);
   This may include filtering the data and information represented by the Feature Graph in accordance with a rule, constraint, threshold, or other condition prior to the evaluation process;
   This may include evaluating the data, information, and metadata in a processing flow that is determined by a specific application or set of controls or instructions;
      In one embodiment, this may include aggregating statistical data and/or metadata, identifying statistically relevant or significant relationships, or generating specified metrics or indicia of relationships or variable values, as non-limiting examples;
      In one embodiment, this may include evaluating the aggregated data using a rule-set or condition to identify potentially important variables or relationships, or to alert a user to a specific condition;
      In one embodiment, this may include performing a type of network analysis on the nodes in a layer to identify network characteristics; and
Presenting the results of the graph traversal and evaluation to a user (as suggested by step or stage 196);
   In one embodiment, this may include separating the topic(s), variables, and data used to generate the Feature Graph into distinct layers of nodes and connecting edges between nodes and layers;
   In one embodiment, this may include indicating to the user a relationship between two nodes having certain characteristics (such as strength, recency, exceeding a threshold value, or being more reliable, as examples);
   In one embodiment, this may include presenting a list or table to the user specifying concepts or topics which impact or are impacted by the input concept or topic with metadata for the properties of this relationship;
   In one embodiment, this may include associating a set of variables or a topic with a metric and indicating a value and/or change in the metric to the user;
   In one embodiment, this may include representing a relationship between two variables, between two topics, or between a variable and a topic using one or more metrics or indicia (e.g., flags, alerts, or colors) regarding the statistical relationship between those entities.

FIG. 1(d) is a diagram illustrating an example of part of a Feature Graph data structure 198 that may be used to organize and access data and information, and which may be created using an implementation of an embodiment of the system and methods disclosed herein. A description of the elements or components of the Feature Graph 198 and the associated Data Model implemented is provided below.

Feature Graph
As noted, a Feature Graph¹ is a way to structure, represent, and store statistical relationships between topics and their associated variables, factors, or categories. The core elements or components (i.e., the “building blocks”) of a Feature Graph are variables (identified as V1, V2, etc. in FIG. 1(d)) and statistical associations (identified as connecting lines or edges between variables). Variables may be linked to or associated with a “concept” (an example of which is identified as C1 in the figure), which is a sematic concept or topic that is typically not, in and of itself, directly measurable or measurable in a useful manner (for example, the variable “number of robberies” may be linked to the concept “crime”). Variables are measurable empirical objects or factors. In statistics, an association is defined as “a statistical relationship, whether causal or not, between two random variables.” Statistical associations result from one or more steps or stages of what is often termed the Scientific Method, and may, for example, be characterized as weak, strong, observed, measured, correlative, causal, or predictive, as examples; ¹ In the context of the disclosure, the term “feature graph” is used because embodiments assemble the graph from entities connected through statistical relationships between variables (the measures of interest), referred to herein as features, instead of a semantic co-occurrence (as in a conventional “knowledge graph”).
   As an example and with reference to FIG. 1(d), a statistical search for input variable V1 retrieves: (i) variables statistically associated with V1 (e.g., V6, V2) (in some embodiments, a variable may only be retrieved if a statistical association value is above a defined threshold), (ii) variables statistically associated with those variables (e.g., V5, V3, V4) (in some embodiments, a variable may only be retrieved if a statistical association value is above a defined threshold), (iii) variables semantically related by a common concept (e.g., C1) to a variable or variables (e.g., V2) that are statistically associated to the input variable V1 (e.g., V7), (iv) variables statistically associated to those variables (e.g., V8); and the datasets measuring the associated variables or demonstrating the statistical association of the retrieved variables (e.g., D6, D2, D5, D3, D4, D7, D8);
      note that in contrast to the disclosed embodiments, a semantic search for input variable V1 retrieves: (1) the variable V1, and (2) the dataset(s) measuring that variable (e.g., D1);
A Feature Graph is populated with information and data about statistical associations retrieved from (for example) journal articles, scientific and technical databases, digital “notebooks” for research and data science, experiment logs, data science and machine learning platforms, a public website where users can input observed or perceived statistical relationships, proprietary business information, and/or other possible sources;
   As noted, using natural language processing (NLP), natural language understanding (NLU), and/or image processing (OCR, visual/image processing and recognition) techniques, components of the information and data retrieval architecture (an example of which is illustrated in FIG. 1(a)) can scan or “read” published scientific journal articles, identify words or images that indicate a statistical association has been measured (for example, “increases”), and retrieve information and data about the association, and about datasets that measure or confirm the association;
   Other components of the information and data retrieval architecture provide data scientists and researchers with a way to input code into their digital “notebook” (e.g., a Jupyter Notebook) to retrieve the metadata output of a machine learning experiment (e.g., the “feature importance” measurements of features used in a model) and information about datasets used in an experiment. Note that information and data retrieval is happening regularly and, in some cases, continuously, providing the system with new information to store and structure and expose to users;
In one embodiment, datasets are associated to variables in a Feature Graph with links to the URI of the relevant dataset/bucket/pipeline or other form of access or address;
   This allows a user of the Feature Graph to retrieve datasets based on the previously demonstrated or determined predictive power of that data with regards to a specified target or topic (rather than potentially less relevant or irrelevant datasets about topics semantically related to a specified target or topic, as in a conventional knowledge graph, which is based on semantic co-occurrence between sources);
   For example, using an embodiment of the system and methods disclosed herein, if a data scientist searches for “vandalism” as a target topic or goal of a study, they will retrieve datasets for topics that have been shown to predict that target or topic—for example, “household income,” “luminosity,” and “traffic density” (and the evidence of those statistical associations to the target)—rather than datasets measuring instances of vandalism;
Numerical values (e.g., 0.725) and statistical properties (e.g., p-value=0.03) of an association are stored in SystemDB 108 as retrieved and may be made available as part of a constructed Feature Graph. As mentioned, given that researchers and data scientists may employ different words to describe the same or a similar concept or topic, variable names (e.g., “aerobic exercise”) are stored as retrieved and may be semantically grounded to public domain ontologies (e.g., Wikidata), dictionaries, thesauruses, or a similar source) to facilitate clustering of variables (and the accompanying statistical associations) based on common or similar concepts (such as synonymous terms or terms understood to be interchangeable by those in an industry);
In one sense, system 100 employs mathematical, language-based, and visual methods to express the epistemological and underlying properties of the data and information available, for example the quality, rigor, trustworthiness, reproducibility, and completeness of the information and/or data supporting a given statistical association (as non-limiting examples);
   For example, a given statistical association might be associated with specific score(s), label(s), and/or icon(s) in a user interface, with these indications based on its scientific quality (overall and/or with regards to specific parameters such as “has been peer reviewed”) to indicate to the user information they may use to decide whether to investigate the association further. In some embodiments, statistical associations retrieved by searching the Feature Graph may be filtered based on their “scientific quality” scores. In certain embodiments, the computation of a quality score may combine data stored within the Feature Graph (for example, the statistical significance of a given association or the degree to which the association is documented) with data stored outside the Feature Graph (for example, the number of citations received by a journal article from which the association was retrieved, or the h-index of the author of an article);
   For example, a statistical association with characteristics including a high and significant “feature importance” score measured in a model with a high area under the curve (AUC) score, with a partial dependence plot (PDP), and that is documented for reproducibility might be considered a “strong” (and presumably more reliable) statistical association in the Feature Graph and given an identifying color or icon in a graphical user interface;
   Note that in addition to retrieving variables and statistical associations for a topic or concept, an embodiment may also retrieve other variables used in an experiment or study to contextualize a statistical association for a user. This may be helpful (for example) if a user wants to know if certain variables were controlled for in an experiment or what other variables (or features) are included in a model.

Data Model

The primary objects in a Feature Graph (or SystemDB) will typically include one or more of the following, with an indication of information that may be helpful to define that object:
Variable (or Feature)—What are you measuring and in what population?
Concept—What is the topic, hypothesis, idea, or theory you are studying?
Neighborhood—What is the subject you are measuring (this is typically broader than a concept)?
Statistical Association—What is the mathematical basis for and value of the relationship?
Model (or Experiment)—What is the source of the measurement?
Dataset—What is the dataset that was used to suggest or measure a relationship (e.g., model training data) or that measures a variable?
   These objects are related, as illustrated in the example of a Feature Graph in FIG. 1(d):
Variables are linked to other Variables via Statistical Associations;
Statistical Associations result from Models and are supported by Datasets; and
Variables are linked to Concepts and Concepts are linked to (or part of) Neighborhoods.

Referring to FIG. 1(d), as noted, one use of a Feature Graph is to enable a user to search a Feature Graph for one or more datasets that contain variables that have been demonstrated to be statistically associated with a target topic, variable, or concept of a study. As an example usage:
A user inputs a target variable and wants to retrieve datasets that could be used to train a model to predict that target variable, i.e., those that are linked to variables statistically associated with the target variable (as suggested by process 170 in FIG. 1(b));
   For example, and with reference to FIG. 1(d), a statistical search input V1 (in this case a variable) causes an algorithm (for example, breadth-first search (BFS)) to traverse the feature graph (as suggested by step or stage 174 of FIG. 1(b)), and return (as suggested by step or stage 176 of FIG. 1(b)):
      variables statistically associated with V1 (e.g., V6, V2);
         in some embodiments, a variable may only be retrieved if a statistical association value is above a defined threshold;
      variables statistically associated with those variables (e.g., V5, V3, V4);
         in some embodiments, a variable may only be retrieved if a statistical association value is above a defined threshold;
      variables semantically related by a common concept (e.g., C1) to a variable or variables (e.g., V2) that are statistically associated to the input variable V1 (e.g., V7);
      variables statistically associated to those variables (e.g., V8); and
      the datasets measuring or demonstrating the statistical significance of the retrieved variables (e.g., D6, D2, D5, D3, D4, D7, D8);
After traversing the Feature Graph and retrieving potentially relevant datasets, those datasets may be “filtered”, ranked, or otherwise ordered based on the application or use case (as suggested by step or stage 178 of FIG. 1(b)):
   Datasets retrieved through the traversal process described may subsequently be filtered based on criteria input by the user with their search and/or by an administrator of an instance of the software. Example search dataset filters may include one or more of:
      Population and Key: Is the variable of concern measured in the population and key of interest to the user (e.g., a unique identifier of a user, species, city, or company, as examples)? This impacts the user's ability to join the data to a training set for use with a machine learning algorithm;
      Compliance: Does the dataset meet applicable regulatory considerations (e.g., GDPR compliance or HIPAA regulations)?
      Interpretability/Explainability: Is the variable interpretable or understandable by a human?
      Actionable: Is the variable actionable by the user of the model?

In one embodiment, a user may input a concept (represented by C1 in 198 of FIG. 1(d)) such as “crime”, “wealth”, or “hypertension”. In response, the system and methods disclosed herein may identify one or more of the following using a combination of semantic and/or statistical search techniques:
A concept (C2) that is semantically associated with C1 (note that this step may be optional);
Variables (Vx) that are semantically associated with C1 and/or C2;
Variables that are statistically associated with each of the variables Vx;
A measure or measures of the identified statistical association(s); and
Datasets that measure each of the variables Vx and/or that demonstrate or support the statistical association of the variables that are statistically associated with each of the variables Vx.

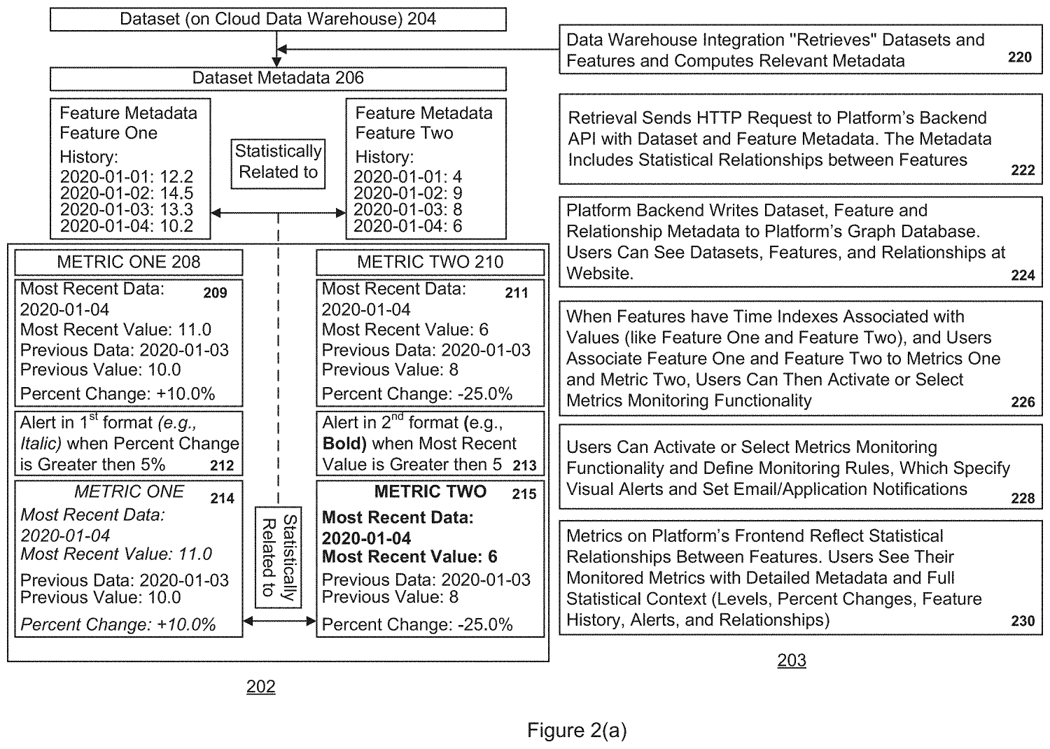

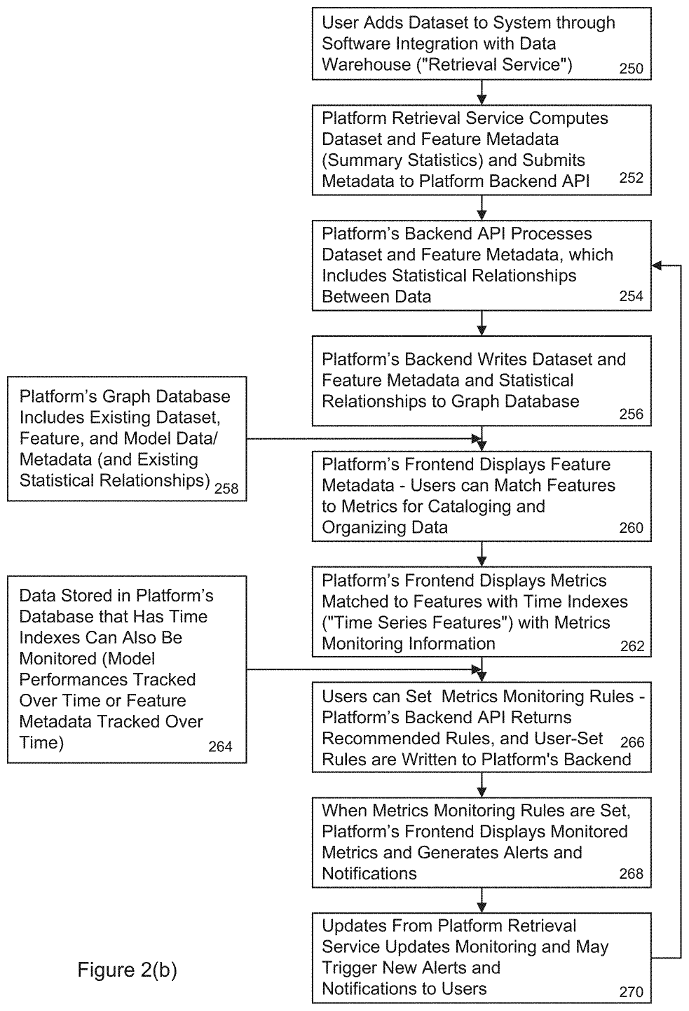

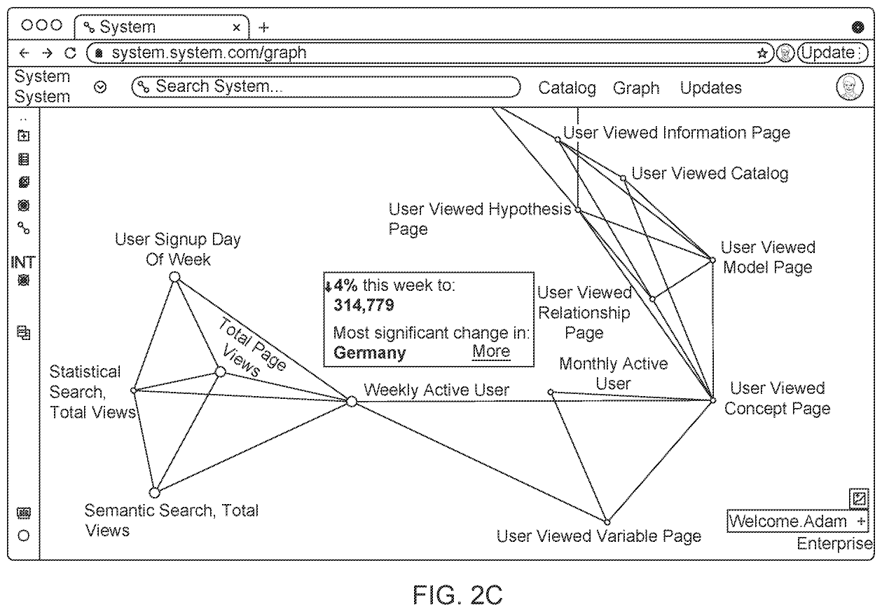

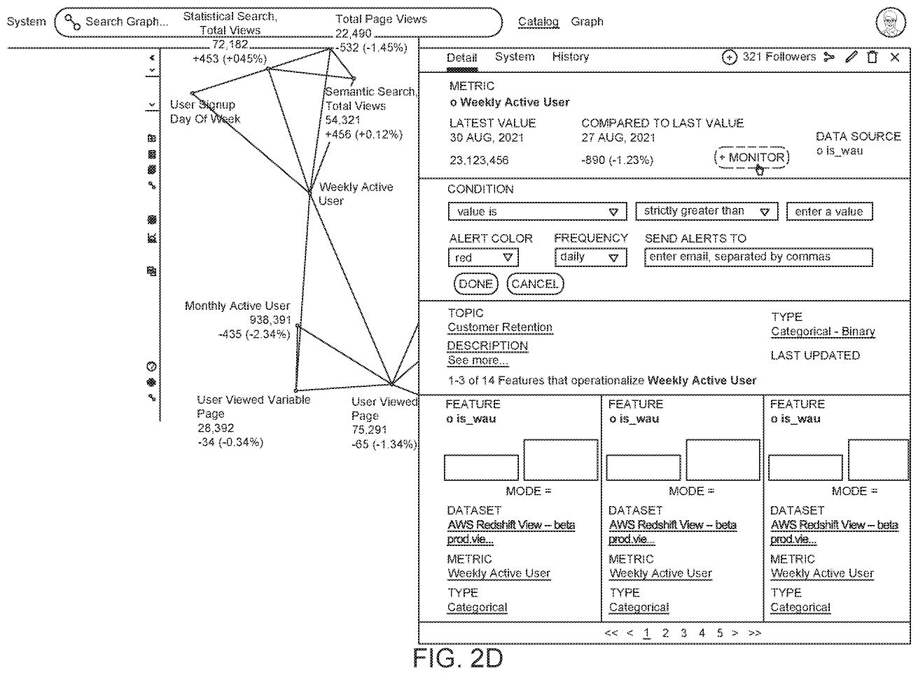

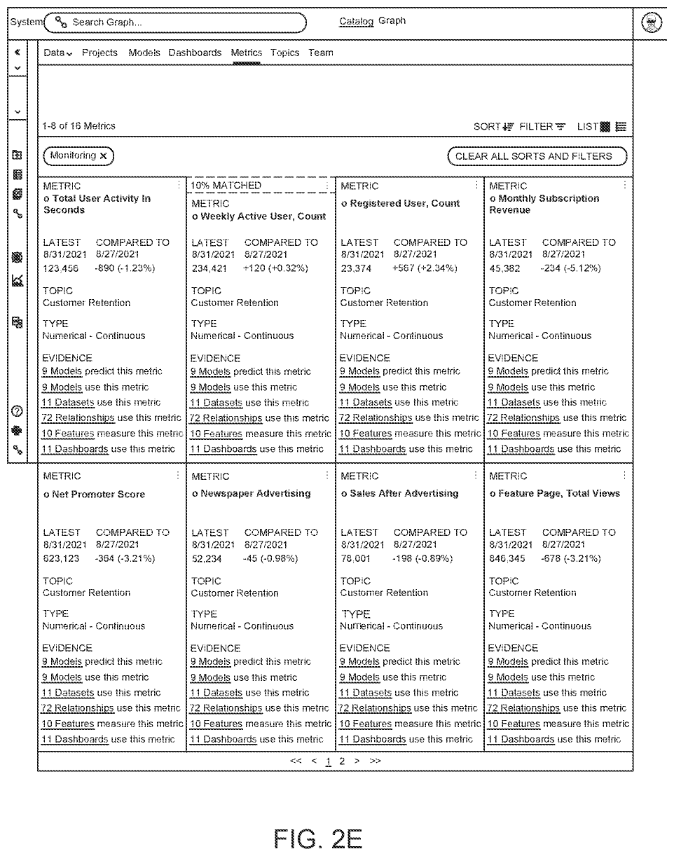

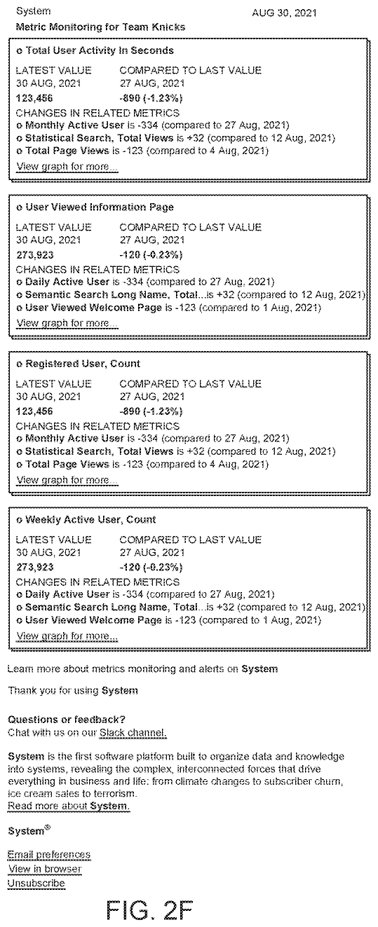

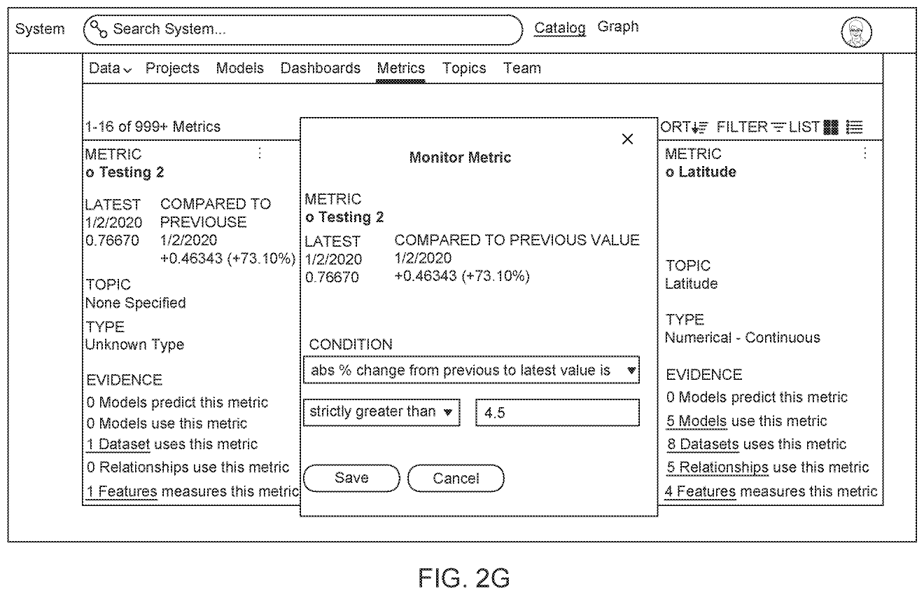

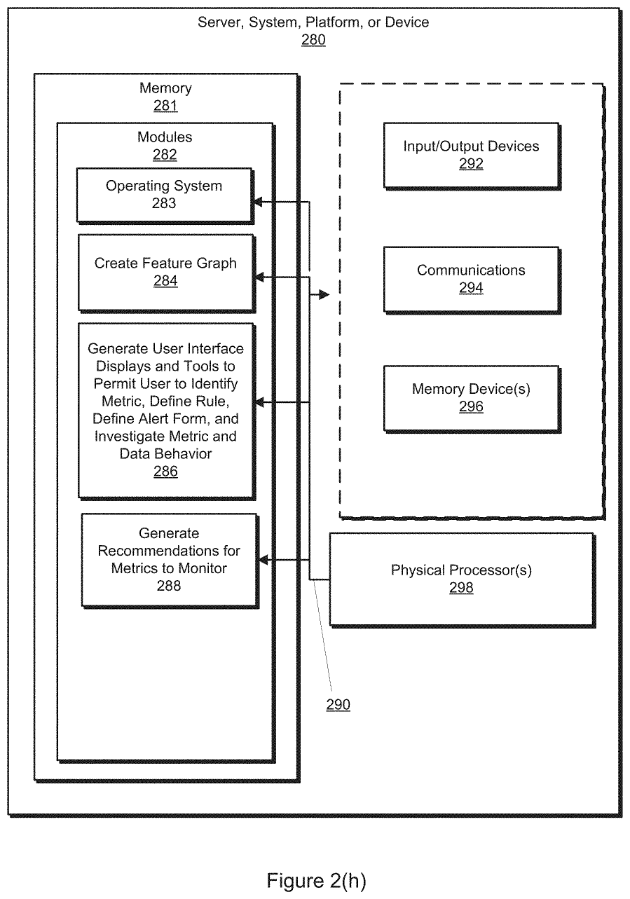

FIG. 2(a) is a block diagram illustrating a set of elements, components, functions, processes, or operations that may be part of a platform architecture in which an embodiment of the disclosed system and methods for metrics monitoring may be implemented. FIG. 2(b) is a flow chart or flow diagram illustrating a set of elements, components, functions, processes, or operations that may be executed as part of a platform architecture in which an embodiment of the disclosed system and methods for metrics monitoring may be implemented. Specifically, FIG. 2(b) depicts certain of the steps in FIG. 2(a) with a greater focus on the different user interactions and software elements that contribute to how the Metrics Monitoring functionality is implemented and made available to users.

FIG. 2(a) depicts how a change in features from a dataset stored in a cloud database service (or “Data Warehouse” 204) may be monitored using an implementation of the disclosed Metrics Monitoring capability. The blocks (for example, Dataset Metadata 206) representing elements, functions, or operations in the left column (indicated by element 202) are examples of how features and metrics are represented on the System platform (along with the measured statistical relationship between features), while the blocks representing elements, functions, or operations on the right side (indicated by element 203) illustrate user interactions, user inputs, and software computations or other executed code that the platform may use to process and store metadata about a dataset and its features.

In some embodiments, the steps, stages, functions, operations, or processing flow illustrated in FIG. 2(a) may include processing steps by which the platform's Data Warehouse Retrieval Integration computes and sends (typically via HTTP requests) relevant metadata to the platform's Backend APIs. The Backend services store the metadata to the platform's Graph Database (such as element 108 of FIG. 1(a)), which contains the data that supports the Feature Graph functionality. The Feature Graph is what users see and interact with using the platform's frontend and generated user interfaces.

Users can interact with the platform's frontend user interface to identify features of interest, and when features have the desired form (i.e., they have numerical values associated with timestamps), users can define metrics for monitoring, connect them with those features, and activate a Metrics Monitoring functionality. Metrics Monitoring provides users with visual indications (on the Feature Graph) depending on the values or changes in values in the metrics (as well as in the platform's underlying data) and may generate alerts and notifications in emails or within the platform application itself.

As mentioned, the Metrics Monitoring functionality or capability will show changes in metrics in context with each other—as suggested in FIG. 2(a), for example, users of the platform will be able to see changes in Metric One (208) alongside changes in Metric Two (210), with a description of the statistical relationship measured between those metrics (as suggested by data 209 and 211, respectively). The platform's context for showing the changes in both metrics displays not only current levels and changes in metrics, but also may use output from machine learning models and other statistical relationships between the underlying features connected to the metrics to generate and display data and information to a user.

FIG. 2(b) depicts certain of the steps in FIG. 2(a) with a greater focus on the user interactions and software elements that contribute to how the Metrics Monitoring functionality is implemented and made available to users. Each step, stage, element, function, or operation of the figure corresponds to a software component (or a software service) of the disclosed platform that contributes to a user being able to use the Metrics Monitoring capability. In the example illustrated in FIG. 2(b), the components shown are (in top-to-bottom sequence in the figure):
Users can add datasets for tracking on the platform through integrations with database services (data warehouses), as suggested by step, stage, operation, process, or function 250;
The Platform's Retrieval service computes relevant dataset and feature metadata and submits HTTP requests to Platform's Backend API(s), as suggested by step, stage, operation, process, or function 252;
Platform's Backend API processes the data payload contained in those requests to prepare dataset and/or feature metadata for storage, as suggested by as suggested by step, stage, operation, process, or function 254;
Platform's Backend Service stores the dataset and/or feature metadata and statistical relationships into a graph database, as suggested by step, stage, operation, process, or function 256;
Platform's Backend Service connects new metadata from the retrieval process to existing metadata in the graph database, so that the datasets and features are connected to existing objects when applicable, as suggested by step, stage, operation, process, or function 258 (note that this is an optional step and depends on the contents of the existing graph database);
Platform's metadata is made available on Platform frontend, with which users can see connections between objects (datasets and features, in one example) that are part of a Feature Graph. Users can also make connections between features and metrics that they are using to track their KPIs or key metrics, as suggested by step, stage, operation, process, or function 260;
When the features are of the right form (for example, data with associated time indices, as suggested by element 264), Platform shows features and metrics with their latest values and recent changes, and may prompt user to turn on Metrics Monitoring, as suggested by step, stage, operation, process, or function 262;
   The Platform or system may also prompt users to turn on Metrics Monitoring and suggest important features and metrics to monitor if those objects have important relationships with metrics that are currently being monitored;
Users can set rules for Metrics Monitoring which govern the visual indications/differentiation presented for monitored metrics and generate alerts and notifications through email and on the Platform—these rules are written to the Platform Backend and stored in the Feature Graph, as suggested by step, stage, operation, process, or function 266;
The conditions that users set are then evaluated to generate the visual differentiation, alerts, and/or notifications that are displayed, as suggested by step, stage, operation, process, or function 268. Platform's Backend also tracks the state of Metrics Monitoring to uncover significant or important relationships between metrics and to make recommendations, as noted above;
These steps or processes are conducted iteratively so that new information or data that is retrieved generates the changes in data that users are interested in monitoring, as suggested by step, stage, operation, process, or function 270 and the control loop connecting to step, stage, operation, process, or function 254.

In some embodiments, the disclosed platform includes, as a part of its architecture, software to automatically retrieve and process data from remote databases and write the computed metadata to a platform data storage (including metadata on the statistical relationships between features in datasets). This architecture is based on microservices that are designed to run on a scheduled and/or event-driven basis. However, this form of implementation may not be required if the updated data is “retrieved” from a source and written to a storage location where the Metrics Monitoring software and functionality can access it. As mentioned, it is desirable for purposes of implementing the metrics monitoring functionality that the data is retrieved in a fashion where the values of interest of the data are associated with specific time periods or other form of index.

For example, an associative array in JavaScript can be used to associate values of data with specific timestamp objects: {“2010-01-01 00:00:00Z”: 10.4, “2010-01-02 00:00:00Z”: 11.2}, where the “keys” of this associative array represent timestamps in the “UTC” time standard, and the numbers following a key represent values of data that are associated with those timestamps. This is one non-limiting example of a data structure that can hold numerical values and associate them with specific timestamps.

Embodiments may include specific ways of interpolating and aggregating data over different time periods and specifying the data values that should be associated with a time period. The Metrics Monitoring functionality disclosed herein will assist users regardless of the method used to “decide” the time period or index associated with each value; however, since users will typically depend on the data to understand how metrics of interest are changing over time, the methodology for doing so should be made clear to the user.

If the data is stored electronically with timestamps associated to values of the data, then in one embodiment, software that implements the Metrics Monitoring functionality may include the following data organization operations or processes:
The “current” or “latest” value is the value associated with the first timestamp when the timestamps are sorted in “descending” time order. The “previous” value is the value associated with the second-to-last timestamp in “descending” time order (refer to elements 209 and 211 of FIG. 2(a));
When only one value exists, the “previous” value is given a “not available”, “N/A”, or “not a number” value, and the percent change is indicated as “not available” (or “N/A” or “not a number”). When neither of these two values are numeric, both values are given as “not available” or “N/A” or “not a number”, as is the percent change;
Otherwise, the percent change is calculated as the current value minus the previous value, divided by the previous value. In the case when the previous value is zero, the platform may represent the percent change as “Inf” for “infinite”;
On the platform, the values are stored in a graph database and are available via HTTP requests to a Backend API. Percent changes can be calculated for users using “frontend” technology, but in some embodiments, Metrics Monitoring writes percent change values to the metric object in the graph database. This is desirable and recommended, as users may want to make queries to the Backend API to get information on the Metrics Monitoring process or status;
Another aspect of the implementation of the Metrics Monitoring capability is the setting and evaluation of the “rules” for monitoring (as suggested by function, operation, or process 212 and 213 of FIG. 2(a)). In one embodiment, as part of the platform architecture, there is included a parameterization of the comparison/alert rules, where a monitoring rule is represented by a “triple” of “field,” “operator,” and “value.”;
   The “field” refers to the field of the Metrics Monitoring object that is stored in the graph database. This field can be “latest value”, “percent change”, or other metadata that can be used by the Metrics Monitoring capability to allow users to monitor KPIs or metrics. This field is designed to be flexible—latest value and percent change are commonly tracked values, but users may want to track “historical maximum (price)” or “52 week low (price)”, as examples for the case of two commonly tracked financial metrics;
   The “value” field is a value that the user can specify (and may have a default value) which serves as basis for comparison in the rule. Since Metrics Monitoring is numerical in nature, it is expected that a user will specify this “value” in numerical terms;
   The “operator” field represents how the mathematical comparisons will be made between the value of the “field” of the monitored metric and the “value” specified by the user (which, as mentioned, may be suggested to the user by the Metrics Monitoring functionality). For example, the operator might be specified as “greater than, in absolute value” which means that the absolute value taken of the value referred to in the “field” will be compared to the supplied “value” to see if it is greater than the “value.”
      The definition of “operator” is preferably flexible enough to encompass monitoring rules that may involve computation or “aggregation” of values stored in the “field.” The implementation of this capability may include an enumeration of operators where predefined software functions (if the programming language utilized allows) implement each operator;
The Metrics Monitoring capability includes a visual element to enable users to quickly see the levels and changes in their monitored metrics. In one implementation of Metrics Monitoring, metrics that require attention, or are in an “alert” phase are depicted either with a user-chosen non-default color, a specified format (such as Italic or Bold) or with an icon (for users who prefer not to distinguish user interface elements with color or format). The choice of a color or format is saved as part of the monitoring rule;
The Metrics Monitoring capability may include a user interface where the user can specify a desired monitoring rule. In one embodiment, this is a language-based “dropdown menu” functionality where users can pick from a set of available “fields,” “operators” and then set “values” to specify a rule. These defined triples (based on user inputs) are saved in the graph database as properties associated with the metric of interest;
One implementation of Metrics Monitoring may also allow users to see what the result of the monitoring would look like as they are specifying or defining a rule. For instance, if the monitoring rule is to set the visual element green when the latest value is greater than 0, then if the latest value of the metric is, in fact greater than 0, the latest value field on the monitoring data is set to green. If the monitoring rule is to set the visual element blue when the percent change is less than 10%, then the percent change value on the monitoring data will be blue if the condition is satisfied. This will change back to a default color or appearance if the user then changes the value in the rule to a comparison value where the condition no longer holds;
A difference between the Metrics Monitoring capability disclosed herein and other cataloguing, dashboard, or analytics tools is that users can see their monitoring information in its full context alongside the results of modeling or other sources of data indicating a statistical relationship. This is a characteristic of the disclosed platform, and the implementation details for showing relationships involving monitored metrics are related to how the disclosed platform has been designed and implemented;
   In this regard, the disclosed platform is built on a graph database, so that each metric object that is being monitored has a potentially rich network of connections, or “edges,” with other objects. The Metrics Monitoring visual element is particularly useful to users when there are many relationships in a graph, and many are being monitored. When this is the case, users can see different connections and understand how and why their chosen metrics have the indicated “patterns” of statistical variation(s);
   In one embodiment, implementing a Metrics Monitoring capability includes specifying data structures to which the monitoring rules can be applied, but also having a storage technology where the metrics of interest are able to be associated across different pieces of metadata;
In addition to the features or capabilities mentioned, in some embodiments, an implementation of the Metrics Monitoring functionality may include the ability for users to discover or be informed of optimal (or more optimal) rules and as a result, learn more about the systems and relationships that are represented by their data;
Note that in the absence of predefined business rules or published goals for KPIs/metrics (as examples), users might not be aware of how best to define rules for metrics monitoring. In one embodiment, this assistance may be provided by a recommendation function that operates to suggest values/metrics for monitoring based on the collected metadata for the feature and metric in question;
   As a non-limiting example, when values for a feature or metric rarely exceed or fall below a certain numerical bound, critical values might be suggested where the user would expect to be alerted or notified only a percentage of the time. Alternatively, the feature and metric in question might be similar to another feature or metric, and the recommended rule might be to monitor both metrics in the same way;
      The disclosed platform, graph database (SystemDB), and backend infrastructure give users the ability to see data and metadata from a large number of sources as a system. This design enables developers and users to quickly query features, variables, and relationships (nodes and edges in the graph) that have similar statistical characteristics and/or similar properties in their metadata;
      This information, which is unique to the disclosed platform, may be used to discover natural candidates for metrics monitoring even in the absence of user-defined metrics monitoring rules or other predefined business rules. For example, a “built-in” recommendation function can take into account many of these statistical characteristics or properties to suggest monitoring rules;
      An implementation of a recommendation function can include queries and code that identify actual KPIs, such as measures of active users (which often predict sales and revenue). In some embodiments, these metrics may be based on one or more of (1) statistical characteristics (such as being highly predictive of other features or being strongly correlated with other measures important to the company), (2) metadata, including feature or variable name, existence as features in multiple datasets, or being tracked for relatively longer periods of time, or (3) measures of usage, such as how many times users visit that variable or feature's page, relative to others;
      A recommendation function can suggest “smart” monitoring rules based on statistical characteristics or metadata of the metric. Training data for how to implement these rules can also be sourced from the public version of the platform—there, users can set metrics monitoring rules for data from various sources, and the effectiveness of those rules (how often they are triggered, and how a user responds to those alerts) can drive iterations of improvements to the performance of a recommendation rules;
         In one embodiment, the “building blocks” for the recommendation functionality are the measuring of similarity in metadata across different features and metrics, as well as indexing the similarity in statistical characteristics. In contrast, generating cross-feature statistical relationships for every feature in a typical data warehouse is often difficult and a computationally expensive exercise;
Such a recommendation functionality may be implemented using suggested rules-based similarity expressions or relationships;
   As a non-limiting example, a first recommended rule might be to set the same rule for any semantically similar metric. One way of implementing this would be to index values of the names of (and possibly other metadata about) metrics in a search service, and when a user is setting monitoring rules for a different metric, causing a similarity score to be calculated for each other monitored metric—the rule associated with the most similar metric is then suggested, along with whatever default rule exists;
   Another possible implementation feature is to suggest monitoring for metrics that are not part of the dataset retrieval/updating process;
      As a non-limiting example, model performance metrics, if updated regularly, may appear similar to timestamp-indexed value arrays that are used for the Metrics Monitoring functionality (which, as mentioned, may be represented by timestamp-indexed value arrays). These may be stored as metadata associated with model objects and are available for users of the disclosed platform. The user interface for the platform may present these time-indexed model performance metrics as additional features that can be connected to other metrics and monitored;
      When model performance metrics have timestamps associated with them, a separate software service or functionality may operate to look for other arrays of data with the same timestamp index (this may result from the use of methods to interpolate or extrapolate between instances of time, if necessary) and compute time series analysis values to develop robust relationships between the time-indexed features.

The disclosed Metrics Monitoring functionality is intended to provide users with the full statistical context and relationships of their monitored KPIs or other metrics. To do so, the platform frontend depicts the feature graph that is constructed using the platform's architecture and the metadata it collects and identifies. The visual cues from the Metrics Monitoring functionality combine with the visual cues of a feature graph to assist users to develop a deeper and fuller understanding of how the data in the graph are related.

The user interface (UI) displays associated with the Metrics Monitoring capability are generated from data stored on the platform backend. When the Metrics Monitoring capability or functionality is activated, the platform frontend applies a defined monitoring rule (or rules) to the most recent value of a metric and to any relevant previous values, and the view provided to a user by the platform may change as a result.

In one embodiment, frontend JavaScript code is used (before rendering the visual representation of the metrics node, either in the feature graph that is part of the platform or for a specific Metric page generated by the platform) to process the defined rule, which is typically stored on the Metric object itself. As mentioned, a rule may be expressed as a collection of the following:
a value (i.e., the critical value or threshold that the metric's value will be compared to);
a field (the source of the metric's value that should be compared as part of the rule—e.g., the level of the most recent value, or the percent change between the most recent and immediately previous value); and
an operator (how the relevant field should be compared to the rule's value—e.g., “greater than or equal to,” or “strictly less than”).

A rule can be selected or defined in one or more places within the platform architecture where metadata about the metric can be edited. In one embodiment, this includes the Metric page, Metric “cards” (where metrics are referenced as part of other objects, such as in Models or Datasets), and in a Matching Console, where users can match Metrics to features. In one embodiment, the rule-setting may consist of three steps:
setting the “rule,” which means choosing thresholds or conditions for when the metric's level or change determines that a user should be alerted;
specifying how any rule “violations” or alerts should be visually displayed (either through color, format, or iconography, as examples); and
how the alerts should be delivered to users (e.g., users may be able to choose a method of notification, such as email or with notifications on the platform, and how frequently these alerts should be delivered).
   Once a rule is defined, the definition of the rule may be displayed on the Metric page.

In one embodiment, the Metrics Monitoring functionality may be performed regardless of whether a rule has been set. If a rule is not set, then the representation of the metric does not trigger an alert (either via notification or visually on the platform), but the latest value, the immediately previous value, and the percent change between the two values may be displayed wherever the metric is displayed (e.g., in the platform graph, on metric pages, and/or in a catalog of metrics being tracked).

The metric values are generated by the platform frontend using a graph query that finds the appropriate values of features used to measure the selected metric. When only one feature having time-specific (indexed) data is connected/related to a metric, that feature is used for the Metrics Monitoring values. If multiple features that have time-specific data are connected to the metric, then the first feature that was connected to the metric is, by default, the feature used for Metrics Monitoring values (although a user may change this default to another feature). In one embodiment, the feature that supplies the values for Metrics Monitoring may be displayed at the top of the Metrics page, along with a link to the feature so that a user can examine each of the features used to generate the Metrics Monitoring data.

The disclosed platform and data model capture information about datasets and models to help users manage, discover, and use the statistical relationships generated from correlations and associations made by machine learning models. The platform data model specifies features, datasets, models, and other objects as nodes, and the platform is built using a graph architecture to store edges between those objects and platform-created objects which encode information about those relationships.

The platform tracks (and may compute) relationship strength based on the statistical properties of datasets and models. In one embodiment, the platform may be regularly updated with scientific standards for how to assess relationship strength, starting with standard measures of statistical significance (such as computed confidence intervals and various forms of statistical hypothesis testing), statistical “rules of thumb,” (such as traditionally accepted levels of effect sizes as defined by Cohen (1962)), and other sources of specific domain knowledge encoded into the platform's backend and machine learning pipelines.

The processing of the platform's discovered and learned statistical relationships, sourced from platform-computed correlations and machine learning models, results in a feature graph that underlies the Metrics Monitoring capability and functionality. The disclosed Metrics Monitoring capability and functionality provides a user with regularly updated metric values from different data sources and may inform the user of important or significant changes in metric levels or metric growth rates. Thus, the feature graph may be used to inform users about changes in KPIs/metrics that can or should be expected. Correlations and machine learning models added to the platform that include data from a current time period may be incorporated into the measurement of statistical relationships; this has the effect of enabling the platform to continually “learn” and improve the knowledge and data that users can access and utilize in making decisions.

As disclosed, the data used to generate the user interface displays for the platform is stored in a graph database. The graph database includes feature nodes, which may be connected to nodes that summarize the statistical information for each of the features, and edges between features and “association” nodes, which aggregate and summarize the statistical relationship(s) between features. The feature nodes may also have edges to metrics nodes, where users (and the platform) store metadata about a metric, and the tracking or supporting information for the metric.

In some embodiments, the disclosed systems and methods provide users with the ability to monitor business related metrics (such as KPIs) and more efficiently evaluate the quality of the underlying data used to generate those metrics. This capability is expected to enable users to make more informed decisions regarding the operation of a business. In some embodiments, this may include implementation of one or more of the following functions or capabilities:
Creating a feature graph comprising a set of nodes and edges, where;
   A node represents one or more of a concept, a topic, a dataset, metadata, a model, a metric, a variable, a measurable quantity, an object, a characteristic, a feature, or a factor (as non-limiting examples);
      In some embodiments, a node may be created in response to discovery of (or obtaining access to) a dataset, metadata, a model, generating an output from a trained model, generating metadata regarding a dataset, or developing an ontology or other form of hierarchical relationship (as non-limiting examples);
   An edge represents a relationship between a first node and a second node, for example a statistically significant relationship, a dependence, or a hierarchical relationship (as non-limiting examples);
      In some embodiments, an edge may be created connecting a first and a second node to represent a statistically valid relationship between two nodes as determined by a machine learning model or other form of evaluation;
   A label associated with an edge may indicate an aspect of the relationship between the two nodes connected by the edge, such as the metadata upon which the relationship between two nodes is based, or a dataset supporting a statistically significant relationship between the two nodes (as non-limiting examples);
Providing a user with user interface displays, tools, features, and selectable elements to enable the user to perform one or more of the functions or operations of:
   Identifying a metric of interest (such as a KPI) for monitoring or tracking;
      Wherein the metric of interest may be generated by a trained model, a formula, an equation, or a rule-set (as non-limiting examples), and further may be based on, generated from, or derived from underlying data that is a function of time (i.e., time-indexed);
   Defining a rule that describes when an alert or notification regarding the behavior of the identified metric should be generated;
      This may be based on an absolute value, a change to the value, a percentage change, a percentage change over a time period, or a threshold value (as non-limiting examples);
   Defining how the result of applying the rule is to be identified or indicated on a user interface display, such as by a color, icon, or format (as non-limiting examples);
   Allowing a user to select a metric for which an alert has been generated and in response, be provided with information regarding one or more of the metric's changes in value over time, the rule satisfied or activated that resulted in the alert or notification, the metric's relationship(s) (if relevant) to other metrics, and available information regarding the datasets, machine learning models, rules, or other factors used to generate the metric (as non-limiting examples);
Generating a recommendation for the user regarding one or more of a different metric or set of metrics that may be of value to monitor, a dataset that may be useful to examine, metadata that may be relevant to the identified metrics, or another aspect of the underlying data or metrics of potential interest to the user;
   Where the recommendation may result (at least in part) from an output generated by a trained machine learning model, a statistical analysis, a study, a comparison to other metrics or datasets, or other form of evaluation.

The disclosed metrics monitoring capability and functionality improve the KPI (or other metric) monitoring and data quality analysis process in an integrated fashion. The metrics monitoring capability provides data quality monitoring that measures statistical properties of datasets, such as (but not limited to) the rate of missing observations in data, or changes in summary statistics (the minimum, maximum, or mean, as examples), and allows users to visualize and understand changes in data in a contextual environment.

In some embodiments, a user may receive an alert or notification indicating a change in data, where these changes are compared across datasets from different sources and are displayed alongside relevant metadata about the data sources and/or the monitored metrics. In contrast to conventional dashboards which display KPIs in an isolated fashion, the disclosed system and methods also display monitored metrics in a graphical format or representation as part of (or in conjunction with) a feature graph. This enables important statistical relationships between metrics to be recognized and enables a user to identify the “co-movement” of important metrics. This capability provides users with an efficient and effective way of assessing the current level and/or growth rate of a metric and to anticipate the future level(s) and growth rates of related metrics.

As described, an embodiment of the disclosed system and methods for monitoring metrics and evaluating the statistical associations of underlying datasets may be used in conjunction with the referenced platform operated by the assignee. This platform may be used to reveal to users underlying relationships that drive tasks, teams, companies, and communities. In one sense, the task of data teams is to create understanding through the collection and analysis of data. The disclosed platform can be used to aggregate that information and display to users the environment and context of the resulting knowledge. Similarly, teams may measure KPIs or other metrics to gauge the relative health of specific parts of their teams, companies, or communities. The disclosed metrics monitoring functionality provides those teams with a better and more complete understanding of a team's (or company's or community's) health, as reflected or indicated by a set of metrics.

In one embodiment, the “System” platform or platform referenced herein and described in U.S. patent application Ser. No. 16/421,249, entitled “Systems and Methods for Organizing and Finding Data (now issued U.S. Pat. No. 11,354,587), includes (as part of a software integration with database services) a “Retrieval” tool that performs automatic retrieval of metadata and statistical properties from a dataset. This automated retrieval capability allows the platform to store time-indexed statistical metadata. In one embodiment, when a time-indexed feature (such as a variable or parameter) exists, users can indicate through a user interface that this is a metric that they would like to monitor. If a metric is monitored, then the user may be shown the current “level” of the data used to measure or determine the value of the metric, in addition to the previous value, and (in some embodiments) the percentage change between the previous and current values.

In one embodiment, the metrics monitoring functionality is not dependent on an automatic retrieval functionality. Instead, when features exist with time indices, a user may be offered the same tools and may “monitor” the metric. This may include metrics that are not actually stored in a database, such as the values of a machine learning model's performance metrics, or the value of different features of importance in a model. These values can also be set for monitoring by a user.

As disclosed, a user may specify “rules” for monitoring a metric based (for example) on either the levels (the values of the metric) and/or percent changes between the current and previous values of the metric. When a user is prompted to specify a rule, the Metrics Monitoring capability can also (or instead) recommend rules, based on similarly monitored metrics, where similarity may be determined by one or more of the statistical properties of the metric, semantic analysis of the name of the metric, or a user's previously specified Metrics Monitoring rules (as non-limiting examples).

Such “recommendations” may include prompts to the user of the form “The recommended threshold for changes in mean is 2.2% (this occurs in 5% of observations).” The form of a user defined, or platform proposed rule depends on the structure and values of the data, but commonly includes rules based on (as examples):
the values of data (e.g., data is positive, at least zero, negative, greater/greater or equal to a specific value, or less than/less than or equal to a specific value);
“absolute” changes in the values of data (e.g., numerical change is exactly zero, numerical change is less than/less than or equal to a specific value, or numerical change is less than/less than or equal to a specific value in absolute value); or
percent changes in the data from its previous value (e.g., percent change is zero, or percent change is greater than a specific value).

In one embodiment, a user may specify multiple rules and can specify whether to be notified/alerted when a specific rule is “violated” or if all the rules are “violated”, where a “violation” of a rule is when the condition specified by the rule is present or satisfied. That is, if the user sets a rule for a metric to be monitored when the value is negative, whenever the metric's value is negative the rule is said to be “violated”—i.e., the condition set in the rule is satisfied.

Based on the rule or rules, the platform may display whether the value (if rules are based on the value) or the change in value (if rules are based on the most recent change in value) is in “violation” of the set rule(s). Such a “violation” represents an “alert” or notification generation state, and in response the platform may change the display of the value (or change in value) in a manner specified by the user. As mentioned, a user may be provided with choices as to how the display changes—for example, by setting a color for the alert state and/or choosing an icon to be shown alongside the value or change in value.

In one embodiment, a default change to the display of the metric is to show the value (or change in value, depending on the rule applied) in red when the rule is in the alert state (when the rule is “violated”) and in green when the rule is not in an alert state. When there are no rules applied, the monitoring may display a default color, which may be black. These settings may be changed by a user, along with accessibility parameters that the user sets on the display of the platform.

In some embodiments, the Metrics Monitoring functionality can provide users with monitoring of objects with which they are not yet familiar. As a non-limiting example, a team might be focused on KPIs and set up the Metrics Monitoring functionality with specific rules. Since the platform is capturing metadata and relationships between metrics, it may be the case that a different metric (or set of metrics), or a performance metric from a machine learning model that has been added to the platform is a “good” predictor or leading indicator of a monitored metric. In this situation, the platform's Metrics Monitoring function may suggest that this metric be monitored and can provide recommendations for more comprehensive and improved monitoring based on machine-learned relationships in the metadata added to the platform.

This capability is built on top of functionality built into the disclosed platform. As part of the construction of the Feature Graph via data retrieval (e.g., a metadata retrieval service that regularly queries a cloud database service), the platform has software processes that automatically calculate statistical relationships between different features and measures the relative strength of those relationships according to a calibration process. As part of the calibration process, closely related metrics can be identified via query, and when a newly-added metric is closely related to a metric that is currently being monitored, this information can be stored in the graph itself. The platform can then prompt users with the appropriate role-based access with a suggestion to open the monitoring model and apply monitoring rules to a newly added metric. Over time, the calibration process will continue to identify new metrics in the same fashion and can also identify existing metrics that are highly related to the set of metrics already being monitored.

As a non-limiting example of a use case, consider the following scenario:
An “enterprise” user may be using the platform to track a set of 16 core KPIs/metrics that the company's leadership team defined and identified as important to the company's operations and business strategy. The platform's integrations with databases and data warehouse services can be used to update statistical metadata about datasets and features, so the 16-core metrics can be connected to regularly updating sources of data. The members of the company's data team can set the appropriate Metrics Monitoring rules to track and alert users when a tracked metric hits a critical level or growth rate.

Determined correlations or machine learning model outputs calculated using the data connected to these metrics are viewable and navigable on the platform generated feature graph, so a “map” of the company's core metrics will be viewable, navigable, and shareable. An enterprise user might access the platform regularly to examine the levels of the core metrics and/or to see how a data team's work is creating additional (or improving existing) statistical relationships between the company's core metrics.

The Metrics Monitoring capability allows a user to track the important metrics that they use to gauge a company's operational status, and the platform feature graph allows them to find connections and/or relationships between metrics. For example, a user might select a UI element connecting two metrics to discover a colleague's models that explored how one metric can be used to “predict” another, as knowing these relationships can provide a more accurate and reliable understanding of operational status. For example, the metadata from models and correlations can quantify the predictive relationship between the average waiting time for orders and the likelihood that a customer reorders from a company, and thereby improve the company's decision making in several areas (e.g., marketing, fulfillment processing, or inventory management).

A user of a public version of the platform (such as is available through www.system.com), might encounter the Metrics Monitoring functionality through browsing a part of the platform feature graph that they are interested in. For example, the public version of the platform may have a metric defined as “Global Nitrogen Dioxide Emissions”. This metric might be connected to a feature that is part of a dataset published by NASA that measures global atmospheric emissions levels, and a user might have used that feature as the basis for Metrics Monitoring of Global Nitrogen Dioxide Emissions.

The public platform UI will then show Global Nitrogen Dioxide Emissions as a metric, and users can visit the metric's page to obtain information on levels or growth changes reported from the metadata retrieved from NASA's published dataset. When connections to other metrics are made, created, or discovered by the platform (whether through specific machine learning modeling, or based on statistical correlations that are computed between the features in the dataset and other features tracked over time on the platform), the connections will be displayed in the graph. This will enable the user to see if other metrics are related to nitrogen dioxide emissions. Using the user interface, the user will be able to see the levels and recent changes for those related metrics and can use the links provided in the platform feature graph to access the statistical and/or scientific basis for the relationships displayed in the graph (and if desired, observe the extent to which those relationships grow stronger or weaker over time).

In some embodiments, this information can be made available to other applications via HTTP API requests (such as by gRPC, REST, and/or GraphQL requests). For example, a call to a metric endpoint will return the platform's metadata about metric(s), and a call to a metrics/associations endpoint will return metadata about which metrics are related to a given metric (and details about the statistical relationship, such as the evidence that substantiates the relationship and the types of models or correlations that contribute to the relationship).

In one embodiment, the metadata made available for metrics that are relevant to the Metrics Monitoring functionality may include one or more of:
Name, Description;
Time Created;
Time Updated;
Created By;
Updated By;
Features Measured;
Metrics Monitoring Status;
Metrics Monitoring Rules; and
Associations that include that Metric.
   Other (or less) metadata may also be provided when the platform is configured to do so.

As another example use case, the data that generates the view(s) or display(s) provided by the platform can be used by a data journalist who covers financial markets. In this use case, the data journalist might query for metrics that have had levels or recent changes that have exceeded predefined thresholds, and then use queries to find related metrics. The information contained in responses to these queries will provide the statistical context for why a metric of interest is at a certain level (or had changes of a particular magnitude) and provide a statistical basis for why other historically related metrics might be expected to move in a certain direction. For example, the data journalist might see that the price of silver traded in a particular commodities market has experienced a significant drop—modeling or correlations calculated using the price of silver would then inform the journalist what other market forces have recently (or historically) been associated with changes in the price of silver, and what further changes in the market might ensue.

A further description of an implementation and the capabilities of the platform are the following:
The platform stores features that have values associated with a specific time—for example, data on weekly/monthly sales or revenue, the yearly value for different countries' GDP, or the daily closing share price for different publicly traded equities. When data of this type is added to the platform, it can be stored with a series of index values corresponding to the specific time (i.e., stored as a timestamp) recorded for each value, and the value itself. When these values are numerical, their levels and changes can be tracked, as the platform understands how to order the data chronologically and can calculate growth rates between specific values;
The platform's data model distinguishes between “features” (which are a collection of data or a set of measurements), and “metrics” (which are user-defined objects of interest that the user wishes to measure and track). For example, a user interested in measuring sales at a company might define “Monthly Total Sales” as a metric of interest; the values of the metric are features (or transformations of features) that are generated from electronic data records stored by the company;
The platform architecture and functions include a way to connect metrics with features into a feature graph. The platform allows users to specify that a certain feature (or features) provide the values used to determine a given metric, which allows other users to understand that the metric is being measured or evaluated using the connected features. The platform architecture then allows connections to be made between metrics and features using relationships inferred from machine learning models and/or from statistical relationships calculated directly from data (e.g., correlations between measures);
The disclosed Metrics Monitoring feature uses these aspects of the platform to provide users with metric monitoring functionality and contextual information. The monitoring capability is based on retrieving data from various sources and aligning it along a commonly stored timestamp-based index. When this index is available on a feature from a dataset on the platform and a user connects/associates such a feature with numeric values to a metric, the visual interface for the metric will (in some embodiments) show the latest and immediately previous value and the percent change between those values;
Metrics Monitoring provides contextual information for a metric since the platform establishes relationships between metrics when models and datasets are added to the platform. Additionally, the common timestamp index allows the platform to automatically compute time series analyses to generate statistically robust relationships between tracked metrics along the time dimension.

The Metrics Monitoring capability can be utilized on data collected from different types of sources, including data that is generated from the platform itself. As an example, for models added to the platform that users update regularly (e.g., via manual updates of models, automatically scheduled updates of models using online machine learning tools or services, or regular updates from deployed machine learning model services such as AWS Sagemaker), model performance metrics may be collected according to a regular time interval. This type of data can also be attached to a metric for monitoring, and statistical relationships between tracked model performance metrics and other measured metrics on the platform can be established (through correlation analysis or explicit modeling). This enables users of the platform to use Metrics Monitoring to manage their models' performance and metrics (as these metrics are often KPIs or key metrics for data science teams) in the context of their other collected data.

In one embodiment, when Metrics Monitoring is available for a feature in a dataset or another piece of data with a time-based index, a visual interface change or indication (showing recent levels and percent change in the data) may be used to notify a user that this is data that can be tracked or monitored. The visual interface may also enable a user to set specific rules so that they can monitor these changes with a greater degree of visual distinction and receive alerts and notifications about changes in the values for a metric. Users can configure the Metrics Monitoring functionality by setting these rules, which are defined in terms of comparing the most recent level of a metric or the change between recent values using a predefined set of comparison operators, as well as options for how to visually indicate when a metric “violates” or satisfies a condition expressed by a rule (and how to notify the user that a “violation” has occurred). Once a rule is set, the visual indicators on the feature graph are set to reflect the chosen colors or format (or marked with an icon for users with a color vision concern), which distinguishes monitored metrics from those that can be monitored but have no rule set for them (which remain the default color or format).

In one embodiment, and either as part of or separate from metrics monitoring, the platform may generate a visualization showing how an underlying feature graph has changed over time or changes that have occurred between different sets of sources. This may be useful in identifying whether a previously identified statistical relationship was substantiated by later work, or if what was believed to be a valid relationship should now be interpreted differently.

This capability supplements metrics monitoring by highlighting the relationship values that have changed over user-identified periods of time. Users can use metrics monitoring to quickly identify important metrics and how their values have changed over time and use this type of capability (as presented in the form of a visualization, for example) to identify whether the values of key metrics changed because the values of metrics that are (statistically) closely related have changed, or whether an underlying statistical relationship is stronger or weaker than once thought. This capability can be made available automatically to platform users, replacing exploratory modeling that a data analyst or scientist might do in a response to changes in key metrics.

In one example embodiment of the rule-setting process, the default rules are pre-filled for users depending on what field on the metric (e.g., current value, previous value, percent change) is being used to set the monitoring rule. The default rules can be configured for different teams that use the platform, as each enterprise or team account will typically have a separate workspace for data and models. This enables configuration settings, including Metrics Monitoring rules, to be stored separately for each separate enterprise or team account. For enterprise and team accounts, the monitoring rules are typically set with rule-of-thumb levels (e.g., the standard rule for metrics might be to alert in red when the percent change in a value is greater than or equal to 5% in absolute value). When an account already has Metrics Monitoring set for different metrics, the platform can recommend that future alerts be set according to settings that already exist for metrics that are semantically similar (i.e., having a name, description, or type that is the same or sufficiently similar). For example, a team might have set a Metrics Monitoring rule to display a “yellow” alert when the value of the “Product X Inventory” is less than 100—a suggested rule for “Product Y Inventory” or “Product X Production” for that user or team might be to set the rule the same as set for “Product X Inventory.”

Rules may also be suggested when metrics are statistically similar. For example, if “Product X Production” is known to be statistically related to “Product X Inventory” because of a machine learning model or other determined statistical association, the suggested rule for “Product X Production” can be the same as for the related metric, or it can be configured to suggest a rule that would occur with similar likelihood to that of the alert set for “Product X Inventory.” The Metrics Monitoring function can be used to discover or “learn” and apply monitoring rules, and this capability provides an advantage over conventional solutions that require rules be set in isolation, without considering the context for different metrics in the same system.

As mentioned, current solutions for monitoring metrics or managing metadata for machine learning models focus on datasets and models in isolation. In contrast, the disclosed platform architecture and its focus on connecting metadata from datasets, models, and other data-oriented work in one place and in a feature graph means that the Metrics Monitoring functionality is not limited to a particular type of metadata. Further, although the metrics monitoring has been described with reference to levels or percent changes of actual features in a dataset, the monitoring functionality can be applied to other metadata collected on the platform that is associated with a corresponding time element.

Although conventional solutions to metadata management or data cataloging may track the number of observations in a particular dataset and provide alerts or notifications when this number changes, the existing solutions do not collect and store statistical relationships between different pieces of tracked metadata. For instance, a team might be tracking the daily model performance for a model deployed “in production,” while actively monitoring (after setting the appropriate rules) 5 KPI metrics using Metrics Monitoring. The platform's feature graph will show the movements of these 5 metrics with contextual highlighting (or other indication) based on the values (or changes) in the metrics compared to the thresholds set in the Metrics Monitoring rules.

Conventional approaches to monitoring metrics do not provide a monitoring framework that is flexible enough to tie movements in metrics from disparate sources, such as model performance data generated from deployed machine learning models with metrics tracked from a different data source. The disclosed platform is designed as a knowledge management tool for the entire data stack, and Metrics Monitoring on the platform is a monitoring, alerting, and context-driven tool for understanding movements in important metrics where the sources for these metrics are distributed.

As described, in some embodiments, the platform may conduct its own automated machine learning modeling on metadata available to the platform. Since the metadata for metrics on the platform can be indexed to the same time span, the platform can “know” or “learn” statistical relationship(s) between the daily model performances (which are stored in the feature graph) and other metrics on the platform that are retrieved from database services (or added by users) and that have a time index.

This capability may enable the discovery of new and significant metrics that a team is not currently monitoring and/or suggest more effective rules for metrics monitoring that highlight key inflection points for the success of a model (e.g., via tracked model performance metrics), or levels/changes in metrics that predict known critical values for other metrics. This can be done unobtrusively through recommendations presented in a rule-setting panel (e.g., by suggesting “better” rules and explaining to users what the platform is “learning” through its automated machine learning).

As an example of this capability and its benefits to a user, the platform can be used to take metric monitoring data (which contains time-indexed indicators for whether a metric is in an “alert” status) and execute a classification model where the previous values (“lagged” values) for other metrics are used to “predict” whether a given metric is in an alert status. The results of this model can be used to identify “better” thresholds for metrics being monitored (which is the case when a particular level or change in a metric is a good predictor of a different metric being in “notification” or “alert” status), or if levels/changes in model performance metrics are predictors of other metrics' alert status (which suggests that users might want to set Metrics Monitoring for that model performance metric).

In some embodiments, the number of statistical comparisons that the platform automatically executes may be limited, to avoid highlighting spurious correlations, and for reasons of computational efficiency. Since the platform's metadata includes knowledge about metrics being monitored and the ones with high usage on the platform (whether in models or in users' browsing behavior), the automated rule generation and recommendation functions can be focused on metrics and objects of relatively high interest and high statistical importance on the platform.

As mentioned, after constructing a Feature Graph for a specific user or set of users, the graph may be traversed to identify variables of interest to a topic or goal of a study, model, or investigation, and if desired, to retrieve datasets that support or confirm the relevance of those variables or that measure variables of interest. Note that the process by which a Feature Graph is traversed may be controlled by one of two methods: (a) explicit user tuning of the search parameters or (b) algorithmic based tuning of the parameters for variable/data retrieval.

Returning to FIGS. 2(a) and 2(b), as mentioned FIG. 2(a) depicts how a change in features from a dataset stored in a cloud database service (or “Data Warehouse” 204) may be monitored using an implementation of the disclosed Metrics Monitoring capability. In the example display shown in the figure, the dataset metadata 206 is illustrated for two statistically related features, indicated as Feature One and Feature 2. A first metric (Metric One 208) is defined, and its most recent value(s) are displayed (209). A rule governing the display of an alert or notification is shown (212), and the resulting information regarding Metric One is shown in display section 214. Similarly, a second metric (Metric Two 210) is defined, its most recent values displayed (211), a rule governing the display of an alert or notification is shown (213), and the resulting information regarding Metric Two is shown in display section 215.

Continuing with the description of the backend processing on the platform that supports generation of the displays shown in element or section 202, as shown in element or section 203, a data warehouse integration process 220 operates to “retrieve” datasets and features from data warehouse 204 and computes or accesses relevant metadata. This retrieval process sends http requests to the platform's backend API with dataset and feature metadata. The metadata includes statistical relationships between features (as suggested by process 222).

The platform backend writes dataset, feature, and relationship metadata to the platform graph database (as suggested by process 224). Users can see datasets, features, and relationships at an available website. When features have time indexes associated with values (such as the examples of feature one and feature two, shown at 206), and users associate feature one and feature two to metric one (208) and metric two (210), users can then activate or select the metrics monitoring functionality (as suggested by process 226).

A user can activate or select the metrics monitoring functionality and then define monitoring rules, which specify (among other aspects) visual alerts and set email/application notifications (as suggested by process 228). In response, metrics available on the platform's frontend reflect statistical relationships between features. Users can see the monitored metrics with detailed metadata and the full statistical context (e.g., levels, percent changes, feature history, alerts, and relationships), as suggested by process 230.

FIGS. 2(c) through 2(g) are examples of user interface displays that may be generated by a platform or system configured to discover or determine and represent statistically meaningful relations between specified metrics, datasets, and machine learning models, in accordance with embodiments of the disclosed platform and system.

FIG. 2(c) is an example of a user interface display illustrating the most recent value (314,779), the percent change to that value (−4%) and identification of the subpopulation with the biggest change (which can be calculated when a metric is defined as an aggregation of values in a table where there are multiple subpopulations/dimensions in the data).

FIG. 2(d) is an example of a user interface display illustrating the Metrics Monitoring panel on the page for Weekly Active User, a defined metric. The data source for weekly average user (wau) is connected and has a time index, so monitoring is available. By selecting the [+ Monitor] button, a user can set/define a rule for monitoring, and then specify the color of the monitoring and the frequency of email alerts. On the platform feature graph to the left of the figure, Metrics Monitoring is turned on for other metrics, and the edges between the nodes in the graph contain metadata that describe the statistical relationships between the metrics. Knowing which metrics are in alert status and understanding the relationships between metrics allows a user to understand statistical drivers of the KPIs/key metrics within the context of their dataset.

FIG. 2(e) is an example of a user interface display illustrating the platform Catalog view of Metrics Monitoring, where it is turned on for the eight metrics on the displayed page. While other solutions for data monitoring may have a view that is similar in some respects (or other chart views, in the case of dashboard tools), an advantage of the Metrics Monitoring function's approach can be seen in the collection of evidence on a given metric at the bottom of each “card” or section. Each metric is used in different models (some are the predicted outcomes for models), and metadata about each metric is viewable by clicking any of the cards, as well as metadata about the relationships between any metrics that have been included in the same machine learning model or in other statistical relationships established by users or by automated machine learning.

FIG. 2(f) is an example of a user interface display illustrating a notification or notifications for the Metrics Monitoring function. The latest and most recent values (along with the percent changes) are displayed, as well as the values for related metrics. These relationships are created from metadata taken from machine learning models added to the platform, from relationships directly added by users, and from automated machine learning that is applied to feature metadata added by users, retrieved from database services, or generated from regular updates from tracked models deployed in production.

FIG. 2(g) is an example of a user interface display illustrating a simplified rule setting dialog. The condition that will apply to this metric will be when the absolute value of the percent change is strictly greater than 4.5. In this example, there is one default color difference—the percent change (73.10%) is larger than 4.5% in absolute value, so the color indication is RED.

FIG. 2(h) is a diagram illustrating elements, components, or processes that may be present in or executed by one or more of a computing device, server, platform, or system 280 configured to implement a method, process, function, or operation in accordance with some embodiments. In some embodiments, the disclosed system and methods may be implemented in the form of an apparatus or apparatuses (such as a server that is part of a system or platform, or a client device) that includes a processing element and a set of executable instructions. The executable instructions may be part of a software application (or applications) and arranged into a software architecture.

In general, an embodiment of the disclosure may be implemented using a set of software instructions that are designed to be executed by a suitably programmed processing element (such as a GPU, TPU, CPU, microprocessor, processor, controller, or computing device, as non-limiting examples). In a complex application or system such instructions are typically arranged into “modules” with each such module typically performing a specific task, process, function, or operation. The entire set of modules may be controlled or coordinated in their operation by an operating system (OS) or other form of organizational platform.

The modules and/or sub-modules may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

As shown in FIG. 2(h), system 280 may represent one or more of a server, client device, platform, or other form of computing or data processing device. Modules 282 each contain a set of executable instructions, where when the set of instructions is executed by a suitable electronic processor (such as that indicated in the figure by “Physical Processor(s) 298”), system (or server, or device) 280 operates to perform a specific process, operation, function, or method.

Modules 282 may contain one or more sets of instructions for performing a method or function described with reference to the Figures, and the disclosure of the functions and operations provided in the specification. These modules may include those illustrated but may also include a greater number or fewer number than those illustrated. Further, the modules and the set of computer-executable instructions that are contained in the modules may be executed (in whole or in part) by the same processor or by more than a single processor. If executed by more than a single processor, the co-processors may be contained in different devices, for example a processor in a client device and a processor in a server.

Modules 282 are stored in a memory 281, which typically includes an Operating System module 284 that contains instructions used (among other functions) to access and control the execution of the instructions contained in other modules. The modules 282 in memory 281 are accessed for purposes of transferring data and executing instructions by use of a “bus” or communications line 290, which also serves to permit processor(s) 298 to communicate with the modules for purposes of accessing and executing instructions. Bus or communications line 290 also permits processor(s) 298 to interact with other elements of system 280, such as input or output devices 292, communications elements 294 for exchanging data and information with devices external to system 280, and additional memory devices 296.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor or co-processors cause the processor or co-processors (or a device, devices, server, or servers in which they are contained) to perform the specific function, method, process, or operation. As mentioned, an apparatus in which a processor or co-processor is contained may be one or both of a client device or a remote server or platform. Therefore, a module may contain instructions that are executed (in whole or in part) by the client device, the server or platform, or both. Such function, method, process, or operation may include those used to implement one or more aspects of the disclosed system and methods, such as for:
Creating a feature graph comprising a set of nodes and edges (as suggested by module 284), where;
   A node represents one or more of a concept, a topic, a dataset, metadata, a model, a metric, a variable, a measurable quantity, an object, a characteristic, a feature, or a factor as non-limiting examples;
   An edge represents a relationship between a first node and a second node, for example a statistically significant relationship, a dependence, or a hierarchical relationship, as non-limiting examples; and
   A label associated with an edge may indicate an aspect of the relationship between the two nodes connected by the edge, such as the metadata upon which the relationship between two nodes is based, or a dataset supporting a statistically significant relationship between the two nodes, as non-limiting examples;
Providing a user with user interface displays, tools, features, and selectable elements to enable the user to perform one or more of the functions of (as suggested by module 286):
   Identifying a metric of interest (such as a KPI) for monitoring or tracking;
   Defining a rule that describes when an alert regarding the behavior of the identified metric should be generated;
   Defining how the result of applying the rule is to be identified or indicated on a user interface display;
   Allowing a user to select a metric for which an alert has been generated and in response, providing information regarding the metric's changes in value overtime, the rule satisfied or activated that resulted in the alert, the metric's relationship(s) (if relevant) to other metrics, and available information regarding the datasets, machine learning models, rules, or other factors used to generate the metric, as non-limiting examples;
Generating a recommendation for the user regarding a different metric or set of metrics that may be of value to monitor, a dataset that may be useful to examine, metadata that may be relevant to the identified metrics, or other aspect of the underlying data or metrics of potential interest to the user (as suggested by module 288);
   Where the recommendation may result (at least in part) from an output generated by a trained machine learning model, a statistical analysis, a study, or other form of evaluation.

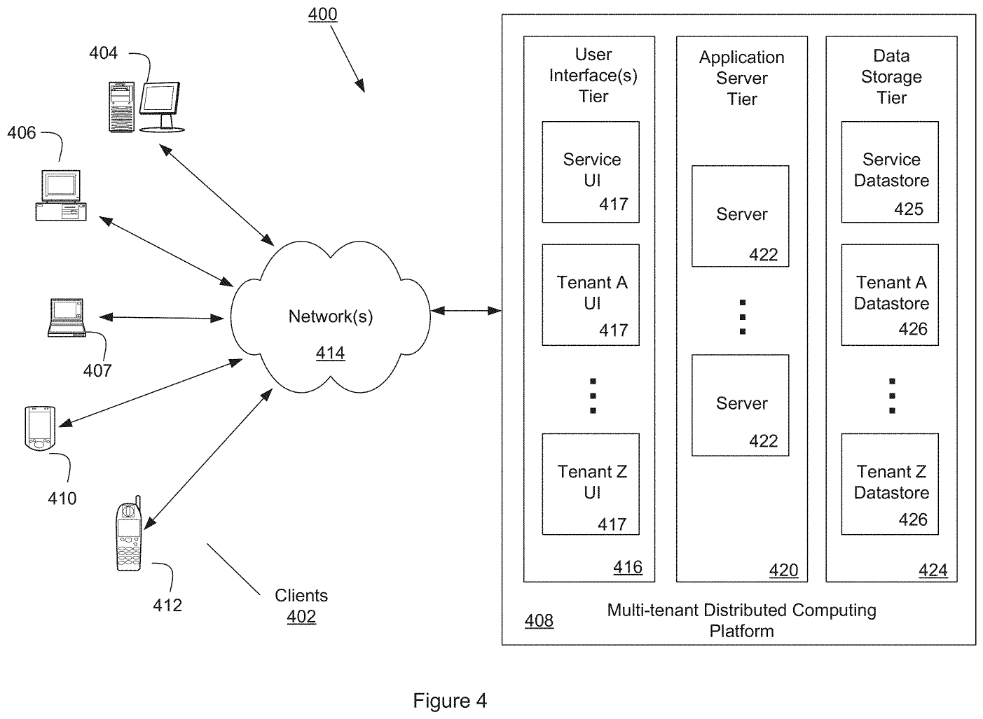

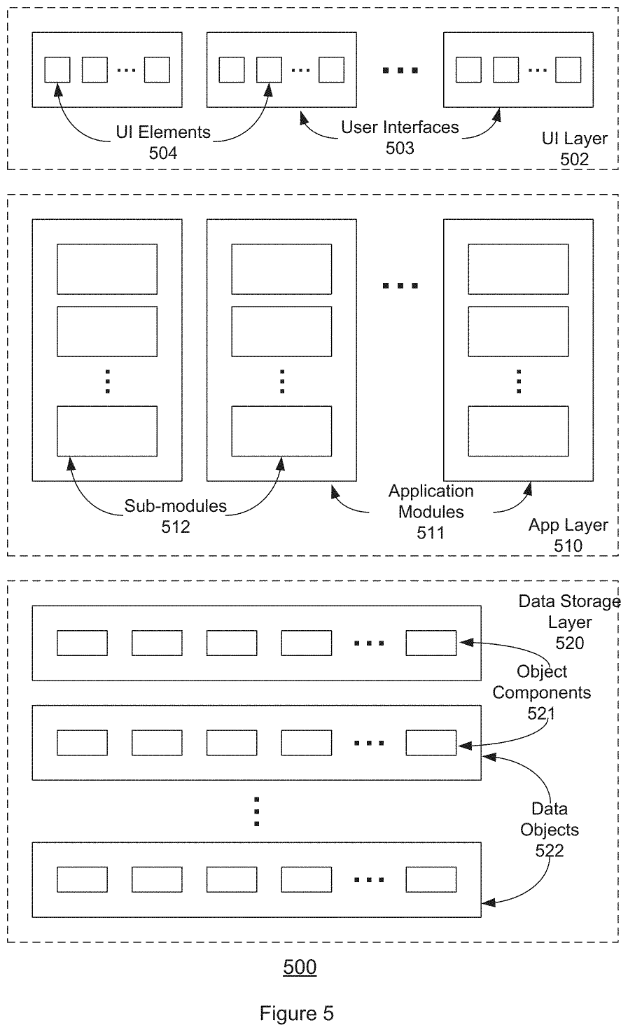

In some embodiments, the functionality and services provided by the system and methods disclosed herein may be made available to multiple users by accessing an account maintained by a server or service platform. Such a server or service platform may be termed a form of Software-as-a-Service (SaaS). FIG. 3 is a diagram illustrating a SaaS system in which an embodiment may be implemented. FIG. 4 is a diagram illustrating elements or components of an example operating environment in which an embodiment may be implemented. FIG. 5 is a diagram illustrating additional details of the elements or components of the multi-tenant distributed computing service platform of FIG. 4, in which an embodiment may be implemented.

In some embodiments, the system or services disclosed or described herein may be implemented as micro-services, processes, workflows, or functions performed in response to the submission of a user's responses. The micro-services, processes, workflows, or functions may be performed by a server, data processing element, platform, or system. In some embodiments, the data analysis and other services may be provided by a service platform located “in the cloud”. In such embodiments, the platform may be accessible through APIs and SDKs. The functions, processes and capabilities may be provided as micro-services within the platform. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 3-5 illustrate a multi-tenant or SaaS architecture that may be used for the delivery of business-related or other applications and services to multiple accounts/users, such an architecture may also be used to deliver other types of data processing services and provide access to other applications. Although in some embodiments, a platform or system of the type illustrated in FIGS. 3-5 may be operated by a 3rd party provider to provide a specific set of business-related applications, in other embodiments, the platform may be operated by a provider and a different business may provide the applications or services for users through the platform.

FIG. 3 is a diagram illustrating a system 300 in which an embodiment may be implemented or through which an embodiment of the services disclosed or described may be accessed. In accordance with the advantages of an application service provider (ASP) hosted business service system (such as a multi-tenant data processing platform), users of the services described herein may comprise individuals, businesses, stores, organizations, etc. A user may access the services using any suitable client, including but not limited to desktop computers, laptop computers, tablet computers, scanners, smartphones, etc. A user interfaces with the service platform across the Internet 308 or another suitable communications network or combination of networks. Examples of suitable client devices include desktop computers 303, smartphones 304, tablet computers, or laptop computers 305.

Platform 310, which may be hosted by a third party, may include a set of services to assist a user to access the data processing and metrics monitoring services described herein 312, and a web interface server 314, coupled as shown in FIG. 3. It is to be appreciated that either or both the services 312 and the web interface server 314 may be implemented on one or more different hardware systems and components, even though represented as singular units in FIG. 3. Services 312 may include one or more functions or operations for enabling a user to access a feature graph and perform the metrics monitoring functions disclosed herein.

As examples, in some embodiments, the set of functions, operations or services made available through platform 310 may include:
Account Management services 318, such as
   a process or service to authenticate a user (in conjunction with submission of a user's credentials using the client device);
   a process or service to generate a container or instantiation of the services or applications that will be made available to the user;
Feature Graph Generating services 320, such as
   a process or service to generate or access the disclosed feature graph comprising a set of nodes and edges connecting certain of the nodes;
User Interface Display and Tools Generating services 322, such as
   a process or service to generate one or more user interface displays and user interface tools and elements to enable a user to;
      Identify a metric of interest (such as a KPI) for monitoring or tracking;
      Define a rule that describes when an alert regarding the behavior of the identified metric should be generated;
      Define how the result of applying the rule is to be identified or indicated on a user interface display;
   Allow the user to select a metric for which an alert has been generated and in response, provide information regarding the metric's changes in value over time, the rule satisfied or activated that resulted in the alert, the metric's relationship(s) (if relevant) to other metrics, and available information regarding the datasets, machine learning models, rules, or other factors used to generate the metric, as non-limiting examples;
Recommendation Generating services 324, such as
   a process or service to generate a recommendation for the user regarding a different metric or set of metrics that may be of value to monitor, a dataset that may be useful to examine, metadata that may be relevant to the identified metrics, or other aspect of the underlying data or metrics of potential interest to the user;
Administrative services 326, such as
   a process or services to enable the provider of the services and/or the platform to administer and configure the processes and services provided to users, such as by altering how a user's data is modeled, how a metric is calculated, or how the resulting metrics and recommendations are presented to a specific user, as non-limiting examples.

Note that in addition to the operations or functions listed, an application module or sub-module may contain computer-executable instructions which when executed by a programmed processor cause a system or apparatus to perform a function related to the operation of the service platform. Such functions may include but are not limited to those related to user registration, user account management, data security between accounts, the allocation of data processing and/or storage capabilities, providing access to data sources other than SystemDB (such as ontologies or reference materials).

The platform or system shown in FIG. 3 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server, as examples. A web server is a most often a combination of hardware and the software that helps deliver content, commonly by hosting a website, to client web browsers that access the web server via the Internet.

FIG. 4 is a diagram illustrating elements or components of an example operating environment 400 in which an embodiment may be implemented. As shown, a variety of clients 402 incorporating and/or incorporated into a variety of computing devices may communicate with a multi-tenant service platform 408 through one or more networks 414. For example, a client may incorporate and/or be incorporated into a client application (i.e., software) implemented at least in part by one or more of the computing devices. Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc. Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow are provided to users, with each business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, in which an embodiment may be implemented. The software architecture shown in FIG. 5 represents an example of an architecture which may be used to implement an embodiment of the invention. In general, an embodiment of the invention may be implemented using a set of software instructions that are designed to be executed by a suitably programmed processing element (such as a CPU, GPU, microprocessor, processor, controller, or computing device). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, in which an embodiment may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as a variety of controls, parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing data processing and services to a user of the platform). Such function, method, process, or operation may include those used to implement one or more aspects of the disclosed system and methods, such as for one or more of the processes, functions, or operations disclosed or described herein.

The application modules and/or sub-modules may include any suitable computer-executable code or set of instructions (e.g., as would be executed by a suitably programmed processor, microprocessor, GPU, TPU, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the disclosure may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The disclosure includes the following clauses and embodiments:
1. A method for monitoring one or more metrics, comprising:
constructing or accessing a feature graph, the feature graph including a set of nodes and a set of edges, wherein each edge in the set of edges connects a node in the set of nodes to one or more other nodes, and further, wherein each node represents a variable found to be statistically associated with a topic and each edge represents a statistical association between a node and the topic or between a first node and a second node;
generating a user interface display and user interface tools to enable a user to perform one or more of
   identifying a metric for monitoring;
   defining a rule that describes when an alert regarding the behavior of the identified metric should be generated;
   defining how the result of applying the rule is indicated on the user interface display; and
   allowing the user to select a metric for which an alert has been generated and in response, provide information regarding one or more of the metric's changes in value over time, the rule that resulted in the alert, the metric's relationship to other metrics, and information regarding the datasets, machine learning models, rules, or factors used to generate the metric.
2. The method of clause 1, further comprising generating a recommendation for the user regarding one or more of a different metric or set of metrics to monitor, a dataset that may be useful to examine, metadata that may be relevant to a metric, or an aspect of the underlying data or metrics.
3. The method of clause 1, wherein constructing the feature graph further comprises:
accessing one or more sources, wherein each source includes information regarding a statistical association between a topic discussed in the source and one or more variables considered in discussing the topic;
processing the accessed information from each source to identify the one or more variables considered, and for each variable, to identify information regarding the statistical association between the variable and the topic; and
storing the results of processing the accessed source or sources in a database, the stored results including, for each source, a reference to each of the one or more variables, a reference to the topic, and information regarding the statistical association between each variable and the topic.
4. The method of clause 3, further comprising storing an element to enable access to a dataset, wherein the dataset includes data used to demonstrate the statistical association between each variable and the topic or data representing a measure of one or more of the variables.
5. The method of clause 4, further comprising:
traversing the feature graph to identify a dataset or datasets associated with one or more variables that are statistically associated with a topic of interest to a user or are statistically associated with a topic semantically related to the topic of interest;
filtering and ranking the identified dataset or datasets; and
presenting the result of filtering and ranking the identified dataset or datasets to the user.
6. The method of clause 3, wherein the one or more sources include at least one source containing proprietary data.
7. The method of clause 6, wherein the proprietary data is obtained from a business, a study, or an experiment.
8. The method of clause 1, wherein the recommendation is generated by one or more of a trained model or a statistical analysis.
9. A system, comprising:
one or more electronic processors configured to execute a set of computer-executable instructions; and
one or more non-transitory computer-readable media containing the set of computer-executable instructions, wherein when executed, the instructions cause the one or more electronic processors or an apparatus or device containing the processors to
   construct or access a feature graph, the feature graph including a set of nodes and a set of edges, wherein each edge in the set of edges connects a node in the set of nodes to one or more other nodes, and further, wherein each node represents a variable found to be statistically associated with a topic and each edge represents a statistical association between a node and the topic or between a first node and a second node;
   generate a user interface display and user interface tools to enable a user to perform one or more of
      identifying a metric for monitoring;
      defining a rule that describes when an alert regarding the behavior of the identified metric should be generated;
      defining how the result of applying the rule is indicated on the user interface display; and
      allowing the user to select a metric for which an alert has been generated and in response, provide information regarding one or more of the metric's changes in value over time, the rule that resulted in the alert, the metric's relationship to other metrics, and information regarding the datasets, machine learning models, rules, or factors used to generate the metric.
10. The system of clause 9, wherein the instructions cause the one or more electronic processors or an apparatus or device containing the processors to generate a recommendation for the user regarding one or more of a different metric or set of metrics to monitor, a dataset that may be useful to examine, metadata that may be relevant to a metric, or an aspect of the underlying data or metrics.
11. The system of clause 9, wherein constructing the feature graph further comprises:
accessing one or more sources, wherein each source includes information regarding a statistical association between a topic discussed in the source and one or more variables considered in discussing the topic;
processing the accessed information from each source to identify the one or more variables considered, and for each variable, to identify information regarding the statistical association between the variable and the topic; and
storing the results of processing the accessed source or sources in a database, the stored results including, for each source, a reference to each of the one or more variables, a reference to the topic, and information regarding the statistical association between each variable and the topic.
12. The system of clause 11, further comprising storing an element to enable access to a dataset, wherein the dataset includes data used to demonstrate the statistical association between each variable and the topic or data representing a measure of one or more of the variables.
13. The system of clause 12, wherein the instructions cause the one or more electronic processors or an apparatus or device containing the processors to:
traverse the feature graph to identify a dataset or datasets associated with one or more variables that are statistically associated with a topic of interest to a user or are statistically associated with a topic semantically related to the topic of interest;
filter and rank the identified dataset or datasets; and
present the result of filtering and ranking the identified dataset or datasets to the user.
14. The system of clause 11, wherein the one or more sources include at least one source containing proprietary data, and further, wherein the proprietary data is obtained from a business, a study, or an experiment.
15. One or more non-transitory computer-readable media comprising a set of computer-executable instructions that when executed by one or more programmed electronic processors, cause the processors or an apparatus or device containing the processors to
construct or access a feature graph, the feature graph including a set of nodes and a set of edges, wherein each edge in the set of edges connects a node in the set of nodes to one or more other nodes, and further, wherein each node represents a variable found to be statistically associated with a topic and each edge represents a statistical association between a node and the topic or between a first node and a second node; and
generate a user interface display and user interface tools to enable a user to perform one or more of
   identifying a metric for monitoring;
   defining a rule that describes when an alert regarding the behavior of the identified metric should be generated;
   defining how the result of applying the rule is indicated on the user interface display; and
   allowing the user to select a metric for which an alert has been generated and in response, provide information regarding one or more of the metric's changes in value over time, the rule that resulted in the alert, the metric's relationship to other metrics, and information regarding the datasets, machine learning models, rules, or factors used to generate the metric.
16. The non-transitory computer-readable media of clause 15, wherein the instructions cause the one or more electronic processors or an apparatus or device containing the processors to generate a recommendation for the user regarding one or more of a different metric or set of metrics to monitor, a dataset that may be useful to examine, metadata that may be relevant to a metric, or an aspect of the underlying data or metrics.
17. The non-transitory computer-readable media of clause 15, wherein constructing the feature graph further comprises:
accessing one or more sources, wherein each source includes information regarding a statistical association between a topic discussed in the source and one or more variables considered in discussing the topic;
processing the accessed information from each source to identify the one or more variables considered, and for each variable, to identify information regarding the statistical association between the variable and the topic; and
storing the results of processing the accessed source or sources in a database, the stored results including, for each source, a reference to each of the one or more variables, a reference to the topic, and information regarding the statistical association between each variable and the topic.
18. The non-transitory computer-readable media of clause 17, further comprising storing an element to enable access to a dataset, wherein the dataset includes data used to demonstrate the statistical association between each variable and the topic or data representing a measure of one or more of the variables.
19. The non-transitory computer-readable media of clause 18, wherein the instructions cause the one or more electronic processors or an apparatus or device containing the processors to:
traverse the feature graph to identify a dataset or datasets associated with one or more variables that are statistically associated with a topic of interest to a user or are statistically associated with a topic semantically related to the topic of interest;
filter and rank the identified dataset or datasets; and
present the result of filtering and ranking the identified dataset or datasets to the user.
20. The non-transitory computer-readable media of clause 17, wherein the one or more sources include at least one source containing proprietary data, and further, wherein the proprietary data is obtained from a business, a study, or an experiment.

The disclosed system and methods can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described herein, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of the specification. Accordingly, embodiments of the disclosure are not limited to the embodiments described or depicted in the drawings, and various embodiments and modifications can be made without departing from the scope of the claims below.

That which is claimed is:

1. A method for monitoring one or more metrics, comprising:
constructing or accessing a feature graph, the feature graph including a set of nodes and a set of edges, wherein each edge in the set of edges connects a node in the set of nodes to one or more other nodes, and further, wherein each node represents a variable found to be statistically associated with a topic and each edge represents a statistical association between a node and the topic or between a first node and a second node;
generating a user interface display and user interface tools to enable a user to perform one or more of
identifying a metric for monitoring;
defining a rule that describes when an alert regarding the behavior of the identified metric should be generated;
defining how the result of applying the rule is indicated on the user interface display; and
allowing the user to select a metric for which an alert has been generated and in response, provide information regarding one or more of the metric's changes in value over time, the rule that resulted in the alert, the metric's relationship to other metrics, and information regarding the datasets, machine learning models, rules, or factors used to generate the metric.

2. The method of claim 1, further comprising generating a recommendation for the user regarding one or more of a different metric or set of metrics to monitor, a dataset that may be useful to examine, metadata that may be relevant to a metric, or an aspect of the underlying data or metrics.

3. The method of claim 1, wherein constructing the feature graph further comprises:
accessing one or more sources, wherein each source includes information regarding a statistical association between a topic discussed in the source and one or more variables considered in discussing the topic;
processing the accessed information from each source to identify the one or more variables considered, and for each variable, to identify information regarding the statistical association between the variable and the topic; and
storing the results of processing the accessed source or sources in a database, the stored results including, for each source, a reference to each of the one or more variables, a reference to the topic, and information regarding the statistical association between each variable and the topic.

4. The method of claim 3, further comprising storing an element to enable access to a dataset, wherein the dataset includes data used to demonstrate the statistical association between each variable and the topic or data representing a measure of one or more of the variables.

5. The method of claim 4, further comprising:
traversing the feature graph to identify a dataset or datasets associated with one or more variables that are statistically associated with a topic of interest to a user or are statistically associated with a topic semantically related to the topic of interest;
filtering and ranking the identified dataset or datasets; and
presenting the result of filtering and ranking the identified dataset or datasets to the user.

6. The method of claim 3, wherein the one or more sources include at least one source containing proprietary data.

7. The method of claim 6, wherein the proprietary data is obtained from a business, a study, or an experiment.

8. The method of claim 1, wherein the recommendation is generated by one or more of a trained model or a statistical analysis.

9. A system, comprising:
one or more electronic processors configured to execute a set of computer-executable instructions; and
one or more non-transitory computer-readable media containing the set of computer-executable instructions, wherein when executed, the instructions cause the one or more electronic processors or an apparatus or device containing the processors to
construct or access a feature graph, the feature graph including a set of nodes and a set of edges, wherein each edge in the set of edges connects a node in the set of nodes to one or more other nodes, and further, wherein each node represents a variable found to be statistically associated with a topic and each edge represents a statistical association between a node and the topic or between a first node and a second node;
generate a user interface display and user interface tools to enable a user to perform one or more of
identifying a metric for monitoring;
defining a rule that describes when an alert regarding the behavior of the identified metric should be generated;
defining how the result of applying the rule is indicated on the user interface display; and
allowing the user to select a metric for which an alert has been generated and in response, provide information regarding one or more of the metric's changes in value over time, the rule that resulted in the alert, the metric's relationship to other metrics, and information regarding the datasets, machine learning models, rules, or factors used to generate the metric.

10. The system of claim 9, wherein the instructions cause the one or more electronic processors or an apparatus or device containing the processors to generate a recommendation for the user regarding one or more of a different metric or set of metrics to monitor, a dataset that may be useful to examine, metadata that may be relevant to a metric, or an aspect of the underlying data or metrics.

11. The system of claim 9, wherein constructing the feature graph further comprises:
accessing one or more sources, wherein each source includes information regarding a statistical association between a topic discussed in the source and one or more variables considered in discussing the topic;
processing the accessed information from each source to identify the one or more variables considered, and for each variable, to identify information regarding the statistical association between the variable and the topic; and
storing the results of processing the accessed source or sources in a database, the stored results including, for each source, a reference to each of the one or more variables, a reference to the topic, and information regarding the statistical association between each variable and the topic.

12. The system of claim 11, further comprising storing an element to enable access to a dataset, wherein the dataset includes data used to demonstrate the statistical association between each variable and the topic or data representing a measure of one or more of the variables.

13. The system of claim 12, wherein the instructions cause the one or more electronic processors or an apparatus or device containing the processors to:
traverse the feature graph to identify a dataset or datasets associated with one or more variables that are statistically associated with a topic of interest to a user or are statistically associated with a topic semantically related to the topic of interest;
filter and rank the identified dataset or datasets; and
present the result of filtering and ranking the identified dataset or datasets to the user.

14. The system of claim 11, wherein the one or more sources include at least one source containing proprietary data, and further, wherein the proprietary data is obtained from a business, a study, or an experiment.

15. One or more non-transitory computer-readable media comprising a set of computer-executable instructions that when executed by one or more programmed electronic processors, cause the processors or an apparatus or device containing the processors to
construct or access a feature graph, the feature graph including a set of nodes and a set of edges, wherein each edge in the set of edges connects a node in the set of nodes to one or more other nodes, and further, wherein each node represents a variable found to be statistically associated with a topic and each edge represents a statistical association between a node and the topic or between a first node and a second node; and
generate a user interface display and user interface tools to enable a user to perform one or more of
identifying a metric for monitoring;
defining a rule that describes when an alert regarding the behavior of the identified metric should be generated;
defining how the result of applying the rule is indicated on the user interface display; and
allowing the user to select a metric for which an alert has been generated and in response, provide information regarding one or more of the metric's changes in value over time, the rule that resulted in the alert, the metric's relationship to other metrics, and information regarding the datasets, machine learning models, rules, or factors used to generate the metric.

16. The non-transitory computer-readable media of claim 15, wherein the instructions cause the one or more electronic processors or an apparatus or device containing the processors to generate a recommendation for the user regarding one or more of a different metric or set of metrics to monitor, a dataset that may be useful to examine, metadata that may be relevant to a metric, or an aspect of the underlying data or metrics.

17. The non-transitory computer-readable media of claim 15, wherein constructing the feature graph further comprises:
accessing one or more sources, wherein each source includes information regarding a statistical association between a topic discussed in the source and one or more variables considered in discussing the topic;
processing the accessed information from each source to identify the one or more variables considered, and for each variable, to identify information regarding the statistical association between the variable and the topic; and
storing the results of processing the accessed source or sources in a database, the stored results including, for each source, a reference to each of the one or more variables, a reference to the topic, and information regarding the statistical association between each variable and the topic.

18. The non-transitory computer-readable media of claim 17, further comprising storing an element to enable access to a dataset, wherein the dataset includes data used to demonstrate the statistical association between each variable and the topic or data representing a measure of one or more of the variables.

19. The non-transitory computer-readable media of claim 18, wherein the instructions cause the one or more electronic processors or an apparatus or device containing the processors to:
traverse the feature graph to identify a dataset or datasets associated with one or more variables that are statistically associated with a topic of interest to a user or are statistically associated with a topic semantically related to the topic of interest;
filter and rank the identified dataset or datasets; and
present the result of filtering and ranking the identified dataset or datasets to the user.

20. The non-transitory computer-readable media of claim 17, wherein the one or more sources include at least one source containing proprietary data, and further, wherein the proprietary data is obtained from a business, a study, or an experiment.
